(19) United States
(12) Patent Application Publication
(10) Pub. No.: US 2014/0086416 A1
(43) Pub. Date: Mar. 27, 2014

(54) SYSTEMS, METHODS, APPARATUS, AND COMPUTER-READABLE MEDIA FOR THREE-DIMENSIONAL AUDIO CODING USING BASIS FUNCTION COEFFICIENTS

(71) Applicant: QUALCOMM Incorporated, San Diego, CA (US)

(72) Inventor: Dipanjan Sen, San Diego, CA (US)

(73) Assignee: QUALCOMM Incorporated, San Diego, CA (US)

(21) Appl. No.: 14/092,507

(22) Filed: Nov. 27, 2013

Related U.S. Application Data
(63) Continuation-in-part of application No. 13/844,383, filed on Mar. 15, 2013.
(60) Provisional application No. 61/671,791, filed on Jul. 15, 2012.
(60) Provisional application No. 61/731,474, filed on Nov. 29, 2012.

(51) Int. Cl. G10L 19/008

(52) U.S. Cl. CPC G10L 19/008
USPC 381/23

(57) ABSTRACT

Systems, methods, and apparatus for a unified approach to encoding different types of audio inputs are described.

This application is a continuation-in-part of U.S. application Ser. No. 13/844,383, filed Mar. 15, 2013, which claims the benefit of U.S. Provisional Application No. 61/671,791, filed Jul. 15, 2012, and this application claims the benefit of U.S. Provisional Application No. 61/731,474, filed Nov. 29, 2012, and the contents of the above applications are hereby incorporated by reference herein as if set forth in its entirety.

### BACKGROUND

1. Field

This disclosure relates to spatial audio coding.

2. Background

The evolution of surround sound has made available many output formats for entertainment nowadays. The range of surround-sound formats in the market includes the popular 5.1 home theatre system format, which has been the most successful in terms of making inroads into living rooms beyond stereo. This format includes the following six channels: front left (L), front right (R), center or front center (C), back left or surround left (Ls), back right or surround right (Rs), and low frequency effects (LFE)). Other examples of surround-sound formats include the growing 7.1 format and the futuristic 22.2 format developed by NHK (Nippon Hoso Kyokai or Japan Broadcasting Corporation) for use, for example, with the Ultra High Definition Television standard. It may be desirable for a surround sound format to encode audio in two dimensions and/or in three dimensions.

### SUMMARY

A method of audio signal processing according to a general configuration includes encoding an audio signal and spatial information for the audio signal into a first set of basis function coefficients that describes a first sound field. This method also includes combining the first set of basis function coefficients with a second set of basis function coefficients that describes a second sound field during a time interval to produce a combined set of basis function coefficients that describes a combined sound field during the time interval. Computer-readable storage media (e.g., non-transitory media) having tangible features that cause a machine reading the features to perform such a method are also disclosed.

An apparatus for audio signal processing according to a general configuration includes means for encoding an audio signal and spatial information for the audio signal into a first set of basis function coefficients that describes a first sound field; and means for combining the first set of basis function coefficients with a second set of basis function coefficients that describes a second sound field during a time interval to produce a combined set of basis function coefficients that describes a combined sound field during the time interval.

An apparatus for audio signal processing according to another general configuration includes an encoder configured to encode an audio signal and spatial information for the audio signal into a first set of basis function coefficients that describes a first sound field. This apparatus also includes a combiner configured to combine the first set of basis function coefficients with a second set of basis function coefficients that describes a second sound field during a time interval to produce a combined set of basis function coefficients that describes a combined sound field during the time interval.

An apparatus configured to perform various aspects of the techniques described in this disclosure comprises a unified encoder for producing a unified encoded signal, and a memory for storing the unified encoded signal.

A method for performing various aspects of the techniques described in this disclosure comprises producing, with a unified encoder, a unified encoded signal, and storing, with a memory, the unified encoded signal.

A method of audio signal processing in accordance with various aspect of the techniques described in this disclosure comprises receiving a plurality of bandwidth compressed spherical harmonic coefficients, having a mode and order, over a transmission channel, and decoding the received bandwidth compressed spherical harmonic coefficient to produce a plurality of synthetic spherical harmonic coefficients.

A device configured to perform various aspects of the techniques described in this disclosure comprises a decoder configured to decode a plurality of bandwidth compressed spherical harmonic coefficients, having a mode and order, configured to produce a plurality of synthetic spherical harmonic coefficients.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1A illustrates an example of L audio objects.

FIG. 1B shows a conceptual overview of one object-based coding approach.

FIGS. 2A and 2B show conceptual overviews of Spatial Audio Object Coding (SAOC).

FIG. 3A shows an example of scene-based coding.

FIG. 3B illustrates a general structure for standardization using an MPEG codec.

FIG. 4 shows examples of surface mesh plots of the magnitudes of spherical harmonic basis functions of order 0 and 1.

FIG. 5 shows examples of surface mesh plots of the magnitudes of spherical harmonic basis functions of order 2.

FIG. 6A shows a flowchart for a method M100 of audio signal processing according to a general configuration.

FIG. 6B shows a flowchart of an implementation T102 of task T100.

FIG. 6C shows a flowchart of an implementation T104 of task T100.

FIG. 7A shows a flowchart of an implementation T106 of task T100.

FIG. 7B shows a flowchart of an implementation M110 of method M100.

FIG. 7C shows a flowchart of an implementation M120 of method M100.

FIG. 7D shows a flowchart of an implementation M300 of method M100.

FIG. 8A shows a flowchart of an implementation M200 of method M100.

FIG. 8B shows a flowchart for a method M400 of audio signal processing according to a general configuration.

FIG. 9 shows a flowchart of an implementation M210 of method M200.

FIG. 10 shows a flowchart of an implementation M220 of method M200.

FIG. 11 shows a flowchart of an implementation M410 of method M400.

FIG. 12A shows a block diagram of an apparatus MF100 for audio signal processing according to a general configuration.

FIG. 12B shows a block diagram of an implementation F102 of means F100.

FIG. 12C shows a block diagram of an implementation F104 of means F100.

FIG. 13A shows a block diagram of an implementation F106 of task F100.

FIG. 13B shows a block diagram of an implementation MF110 of apparatus MF100.

FIG. 13C shows a block diagram of an implementation MF120 of apparatus MF100.

FIG. 13D shows a block diagram of an implementation MF300 of apparatus MF100.

FIG. 14A shows a block diagram of an implementation MF200 of apparatus MF100.

FIG. 14B shows a block diagram for an apparatus MF400 of audio signal processing according to a general configuration.

FIG. 14C shows a block diagram of an apparatus A100 for audio signal processing according to a general configuration.

FIG. 15A shows a block diagram of an implementation A300 of apparatus A100.

FIG. 15B shows a block diagram for an apparatus A400 of audio signal processing according to a general configuration.

FIG. 15C shows a block diagram of an implementation 102 of encoder 100.

FIG. 15D shows a block diagram of an implementation 104 of encoder 100.

FIG. 15E shows a block diagram of an implementation 106 of encoder 100.

FIG. 16A shows a block diagram of an implementation A110 of apparatus A100.

FIG. 16B shows a block diagram of an implementation A120 of apparatus A100.

FIG. 16C shows a block diagram of an implementation A200 of apparatus A100.

FIG. 17A shows a block diagram for a unified coding architecture.

FIG. 17B shows a block diagram for a related architecture.

FIG. 17C shows a block diagram of an implementation UE100 of unified encoder UE10.

FIG. 17D shows a block diagram of an implementation UE300 of unified encoder UE100.

FIG. 17E shows a block diagram of an implementation UE305 of unified encoder UE100.

FIG. 18 shows a block diagram of an implementation UE310 of unified encoder UE300.

FIG. 19A shows a block diagram of an implementation UE250 of unified encoder UE100.

FIG. 19B shows a block diagram of an implementation UE350 of unified encoder UE250.

FIG. 20 shows a block diagram of an implementation 160a of analyzer 150a.

FIG. 21 shows a block diagram of an implementation 160b of analyzer 150b.

FIG. 22A shows a block diagram of an implementation UE260 of unified encoder UE250.

FIG. 22B shows a block diagram of an implementation UE360 of unified encoder UE350.

FIG. 23 is a flowchart of a method M510 of encoding an object-based input according to a general configuration.

FIG. 24 is a flowchart of a method M520 of encoding a channel-based input according to a general configuration.

FIG. 25 is a flowchart of a method M530 of encoding a scene-based input according to a general configuration.

FIG. 26 shows a flowchart of a method M800 according to a general configuration.

FIG. 27 shows a flowchart of a method M810 according to a general configuration.

FIG. 28 shows a flowchart of a method M820 according to a general configuration.

FIG. 29 shows a flowchart of a method M900 according to a general configuration.

FIG. 30 shows a flowchart of task Z300a.

FIG. 31 shows a flowchart of task Z300b.

FIG. 32 shows a block diagram of an apparatus MF800 according to a general configuration.

FIG. 33 shows a block diagram of an apparatus MF810 according to a general configuration.

FIG. 34 shows a block diagram of an apparatus MF820 according to a general configuration.

FIG. 35 shows a block diagram of an apparatus MF900 according to a general configuration.

FIG. 36 shows a block diagram of means Z30a.

FIG. 37 shows a block diagram of means Z30b.

FIGS. 38 to 44 show examples of devices for decoding and rendering bitstreams that include sets of SHC.

### DETAILED DESCRIPTION

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, estimating, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Unless expressly limited by its context, the term “selecting” is used to indicate any of its ordinary meanings, such as identifying, indicating, applying, and/or using at least one, and fewer than all, of a set of two or more. Where the term “comprising” is used in the present description and claims, it does not exclude other elements or operations. The term “based on” (as in “A is based on B”) is used to indicate any of its ordinary meanings, including the cases (i) “derived from” (e.g., “B is a precursor of A”), (ii) “based on at least” (e.g., “A is based on at least B”) and, if appropriate in the particular context, (iii) “equal to” (e.g., “A is equal to B” or “A is the same as B”). Similarly, the term “in response to” is used to indicate any of its ordinary meanings, including “in response to at least.”

References to a “location” of a microphone of a multi-microphone audio sensing device indicate the location of the center of an acoustically sensitive face of the microphone, unless otherwise indicated by the context. The term “channel” is used at times to indicate a signal path and at other times to indicate a signal carried by such a path, according to the particular context. Unless otherwise indicated, the term “series” is used to indicate a sequence of two or more items. The term “logarithm” is used to indicate the base-ten logarithm, although extensions of such an operation to other bases are within the scope of this disclosure. The term “frequency component” is used to indicate one among a set of frequencies or frequency bands of a signal, such as a sample of a frequency domain representation of the signal (e.g., as produced by a fast Fourier transform) or a subband of the signal (e.g., a Bark scale or mel scale subband).

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Unless expressly limited by its context, the term “system” is used herein to indicate any of its ordinary meanings, including “a group of elements that interact to serve a common purpose.”

Any incorporation by reference of a portion of a document shall also be understood to incorporate definitions of terms or variables that are referenced within the portion, where such definitions appear elsewhere in the document, as well as any figures referenced in the incorporated portion. Unless initially introduced by a definite article, an ordinal term (e.g., “first,” “second,” “third,” etc.) used to modify a claim element does not by itself indicate any priority or order of the claim element with respect to another, but rather merely distinguishes the claim element from another claim element having a same name (but for use of the ordinal term). Unless expressly limited by its context, each of the terms “plurality” and “set” is used herein to indicate an integer quantity that is greater than one.

The current state of the art in consumer audio is spatial coding using channel-based surround sound, which is meant to be played through loudspeakers at pre-specified positions. Channel-based audio involves the loudspeaker feeds for each of the loudspeakers, which are meant to be positioned in a predetermined location (such as for 5.1 surround sound/home theatre and the 22.2 format).

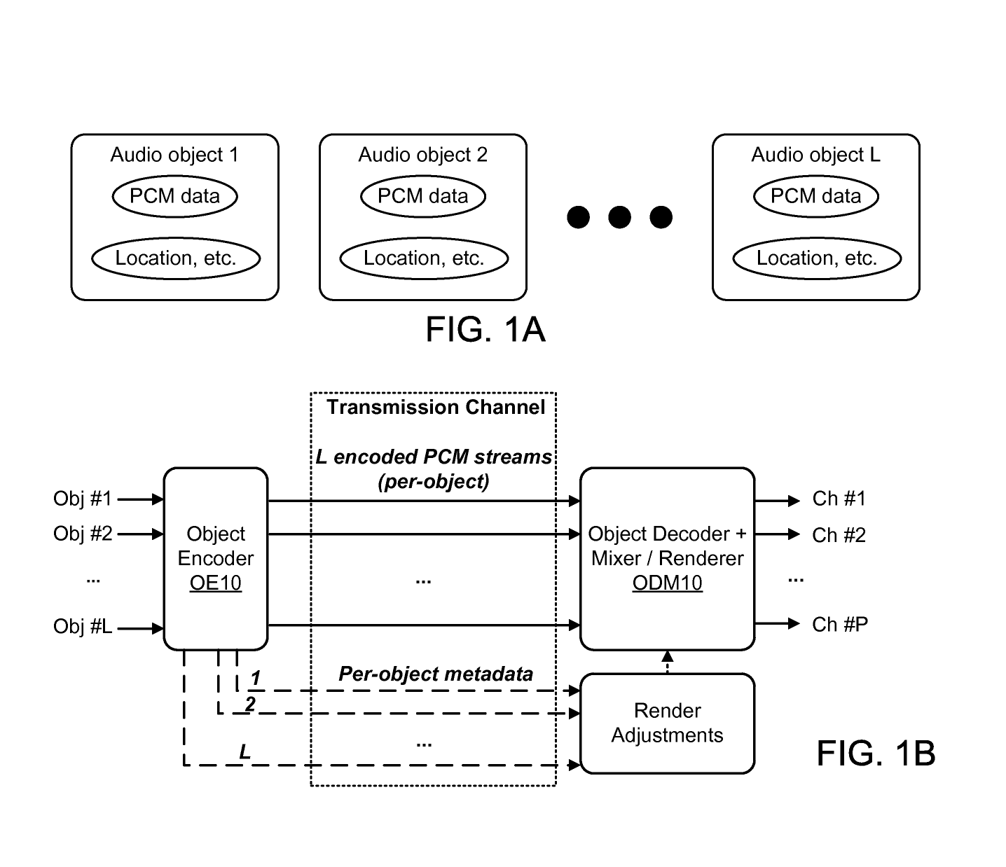

Another main approach to spatial audio coding is object-based audio, which involves discrete pulse-code-modulation (PCM) data for single audio objects with associated metadata containing location coordinates of the objects in space (amongst other information). An audio object encapsulates individual pulse-code-modulation (PCM) data streams, along with their three-dimensional (3D) positional coordinates and other spatial information encoded as metadata. In the content creation stage, individual spatial audio objects (e.g., PCM data) and their location information are encoded separately. FIG. 1A illustrates an example of L audio objects. At the decoding and rendering end, the metadata is combined with the PCM data to recreate the 3D sound field.

Two examples that use the object-based philosophy are provided here for reference. FIG. 1B shows a conceptual overview of the first example, an object-based coding scheme in which each sound source PCM stream is individually encoded and transmitted by an encoder OE10, along with their respective metadata (e.g., spatial data). At the renderer end, the PCM objects and the associated metadata are used (e.g., by decoder/mixer/renderer ODM10) to calculate the speaker feeds based on the positions of the speakers. For example, a panning method (e.g., vector base amplitude panning or VBAP) may be used to individually spatialize the PCM streams back to a surround-sound mix. At the renderer end, the mixer usually has the appearance of a multi-track editor, with PCM tracks laying out and spatial metadata as editable control signals.

Although an approach as shown in FIG. 1B allows maximum flexibility, it also has potential drawbacks. Obtaining individual PCM audio objects from the content creator may be difficult, and the scheme may provide an insufficient level of protection for copyrighted material, as the decoder end can easily obtain the original audio objects. Also the soundtrack of a modern movie can easily involve hundreds of overlapping sound events, such that encoding each PCM individually may fail to fit all the data into limited-bandwidth transmission channels even with a moderate number of audio objects. Such a scheme does not address this bandwidth challenge, and therefore this approach may be prohibitive in terms of bandwidth usage.

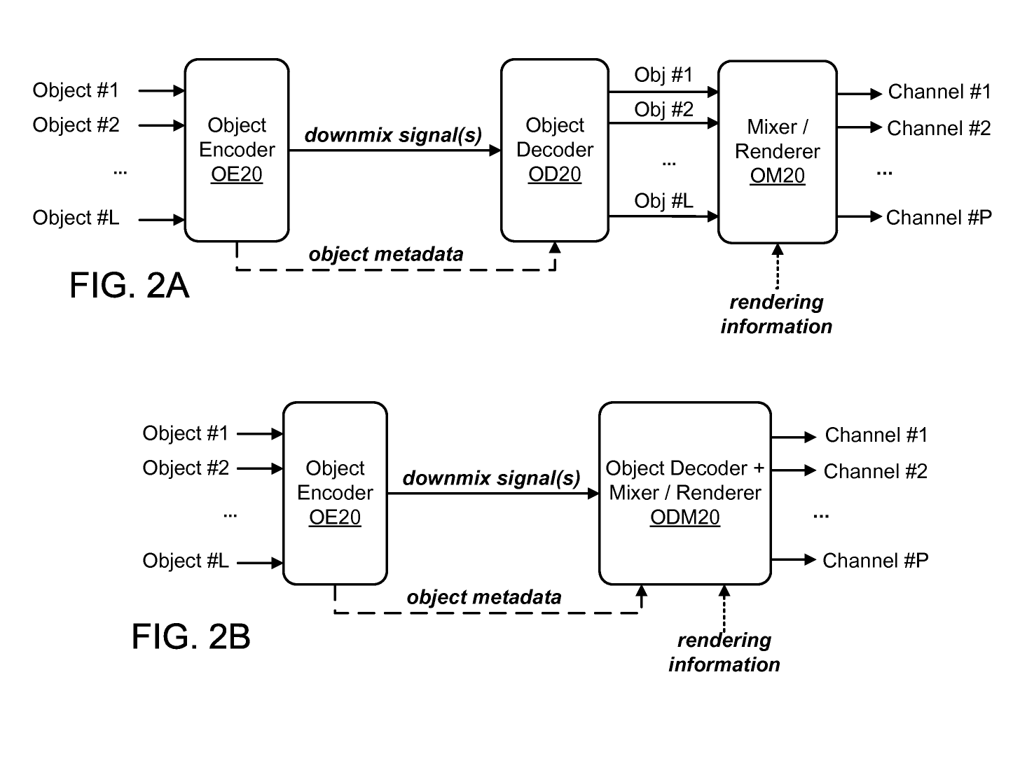

The second example is Spatial Audio Object Coding (SAOC), in which all objects are downmixed to a mono or stereo PCM stream for transmission. Such a scheme, which is based on binaural cue coding (BCC), also includes a metadata bitstream, which may include values of parameters such as interaural level difference (ILD), interaural time difference (ITD), and inter-channel coherence (ICC, relating to the diffusivity or perceived size of the source) and may be encoded (e.g., by encoder OE20) into as little as one-tenth of an audio channel. FIG. 2A shows a conceptual diagram of an SAOC implementation in which the decoder OD20 and mixer OM20 are separate modules. FIG. 2B shows a conceptual diagram of an SAOC implementation that includes an integrated decoder and mixer ODM20.

In implementation, SAOC is tightly coupled with MPEG Surround (MPS, ISO/IEC 14496-3, also called High-Efficiency Advanced Audio Coding or HeAAC), in which the six channels of a 5.1 format signal are downmixed into a mono or stereo PCM stream, with corresponding side-information (such as ILD, ITD, ICC) that allows the synthesis of the rest of the channels at the renderer. While such a scheme may have a quite low bit rate during transmission, the flexibility of spatial rendering is typically limited for SAOC. Unless the intended render locations of the audio objects are very close to the original locations, it can be expected that audio quality will be compromised. Also, when the number of audio objects increases, doing individual processing on each of them with the help of metadata may become difficult.

For object-based audio, it may be desirable to address the excessive bit-rate or bandwidth that would be involved when there are many audio objects to describe the sound field. Similarly, the coding of channel-based audio may also become an issue when there is a bandwidth constraint.

A further approach to spatial audio coding (e.g., to surround-sound coding) is scene-based audio, which involves representing the sound field using coefficients of spherical harmonic basis functions. Such coefficients are also called “spherical harmonic coefficients” or SHC. Scene-based audio is typically encoded using an Ambisonics format, such as B-Format. The channels of a B-Format signal correspond to spherical harmonic basis functions of the sound field, rather than to loudspeaker feeds. A first-order B-Format signal has up to four channels (an omnidirectional channel W and three directional channels X,Y,Z); a second-order B-Format signal has up to nine channels (the four first-order channels and five additional channels R,S,T,U,V); and a third-order B-Format signal has up to sixteen channels (the nine second-order channels and seven additional channels K,L,M,N,O,P,Q).

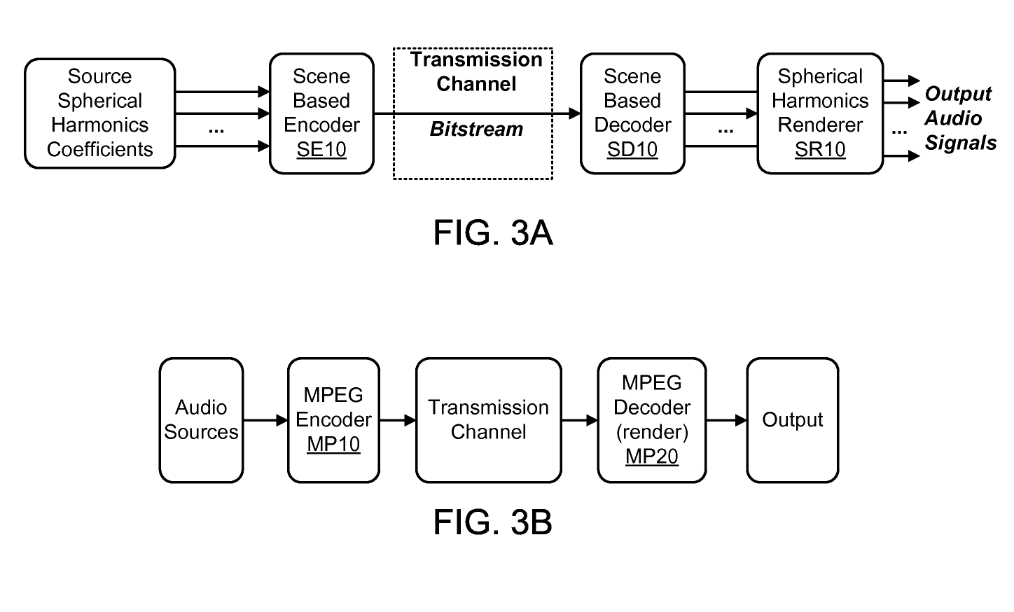

FIG. 3A depicts a straightforward encoding and decoding process with a scene-based approach. In this example, scene-based encoder SE10 produces a description of the SHC that is transmitted (and/or stored) and decoded at the scene-based decoder SD10 to receive the SHC for rendering (e.g., by SH renderer SR10). Such encoding may include one or more lossy or lossless coding techniques for bandwidth compression, such as quantization (e.g., into one or more codebook indices), error correction coding, redundancy coding, etc. Additionally or alternatively, such encoding may include encoding audio channels (e.g., microphone outputs) into an Ambisonic format, such as B-format, G-format, or Higher-order Ambisonics (HOA). In general, encoder SE10 may encode the SHC using techniques that take advantage of redundancies among the coefficients and/or irrelevancies (for either lossy or lossless coding).

It may be desirable to provide an encoding of spatial audio information into a standardized bit stream and a subsequent decoding that is adaptable and agnostic to the speaker geometry and acoustic conditions at the location of the renderer. Such an approach may provide the goal of a uniform listening experience regardless of the particular setup that is ultimately used for reproduction. FIG. 3B illustrates a general structure for such standardization, using an MPEG codec. In this example, the input audio sources to encoder MP10 may include any one or more of the following, for example: channel-based sources (e.g., 1.0 (monophonic), 2.0 (stereophonic), 5.1, 7.1, 11.1, 22.2), object-based sources, and scene-based sources (e.g., high-order spherical harmonics, Ambisonics). Similarly, the audio output produced by decoder (and renderer) MP20 may include any one or more of the following, for example: feeds for monophonic, stereophonic, 5.1, 7.1, and/or 22.2 loudspeaker arrays; feeds for irregularly distributed loudspeaker arrays; feeds for headphones; interactive audio.

It may also be desirable to follow a ‘create-once, use-many’ philosophy in which audio material is created once (e.g., by a content creator) and encoded into formats which can subsequently be decoded and rendered to different outputs and loudspeaker setups. A content creator such as a Hollywood studio, for example, would typically like to produce the soundtrack for a movie once and not expend the effort to remix it for each possible loudspeaker configuration.

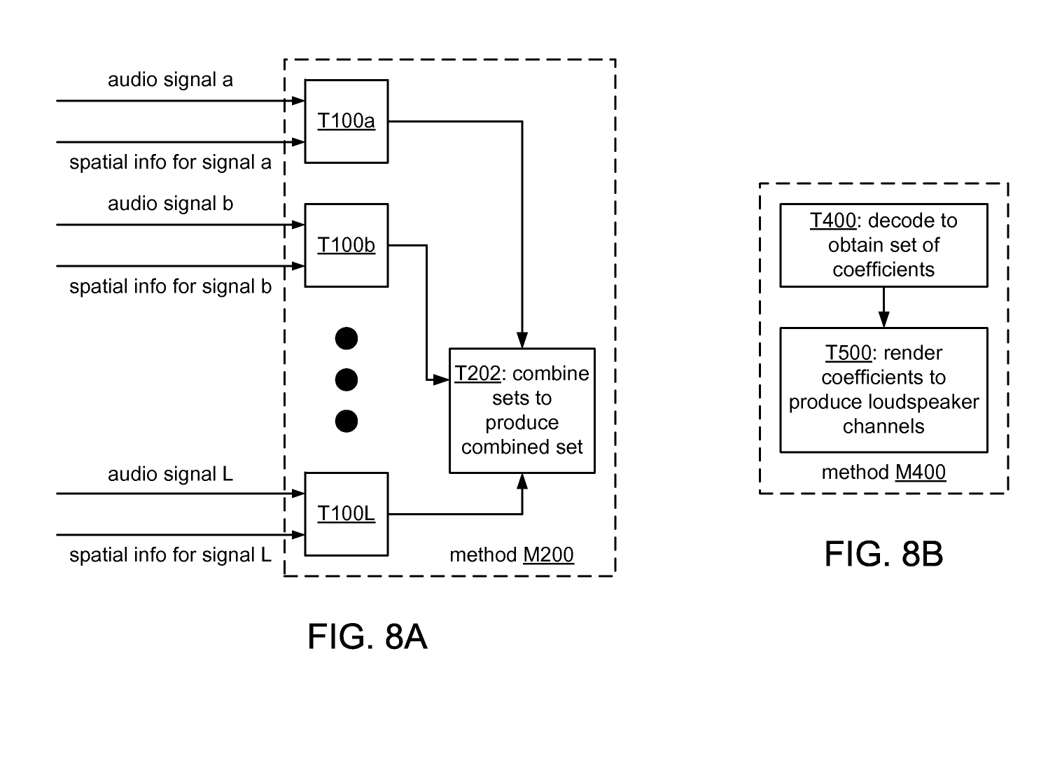

It may be desirable to obtain a standardized encoder that will take any one of three types of inputs: (i) channel-based, (ii) scene-based, and (iii) object-based. This disclosure describes methods, systems, and apparatus that may be used to obtain a transformation of channel-based audio and/or object-based audio into a common format for subsequent encoding. In this approach, the audio objects of an object-based audio format, and/or the channels of a channel-based audio format, are transformed by projecting them onto a set of basis functions to obtain a hierarchical set of basis function coefficients. In one such example, the objects and/or channels are transformed by projecting them onto a set of spherical harmonic basis functions to obtain a hierarchical set of spherical harmonic coefficients or SHC. Such an approach may be implemented, for example, to allow a unified encoding engine as well as a unified bitstream (since a natural input for scene-based audio is also SHC). FIG. 8 as discussed below shows a block diagram for one example AP150 of such a unified encoder. Other examples of hierarchical sets include sets of wavelet transform coefficients and other sets of coefficients of multiresolution basis functions.

The coefficients generated by such a transform have the advantage of being hierarchical (i.e., having a defined order relative to one another), making them amenable to scalable coding. The number of coefficients that are transmitted (and/or stored) may be varied, for example, in proportion to the available bandwidth (and/or storage capacity). In such case, when higher bandwidth (and/or storage capacity) is available, more coefficients can be transmitted, allowing for greater spatial resolution during rendering. Such transformation also allows the number of coefficients to be independent of the number of objects that make up the sound field, such that the bit-rate of the representation may be independent of the number of audio objects that were used to construct the sound field.

A potential benefit of such a transformation is that it allows content providers to make their proprietary audio objects available for the encoding without the possibility of them being accessed by end-users. Such a result may be obtained with an implementation in which there is no lossless reverse transformation from the coefficients back to the original audio objects. For instance, protection of such proprietary information is a major concern of Hollywood studios.

Using a set of SHC to represent a sound field is a particular example of a general approach of using a hierarchical set of elements to represent a sound field. A hierarchical set of elements, such as a set of SHC, is a set in which the elements are ordered such that a basic set of lower-ordered elements provides a full representation of the modeled sound field. As the set is extended to include higher-order elements, the representation of the sound field in space becomes more detailed.

The source SHC (e.g., as shown in FIG. 3A) may be source signals as mixed by mixing engineers in a scene-based-capable recording studio. The source SHC may also be generated from signals captured by a microphone array or from a recording of a sonic presentation by a surround array of loudspeakers. Conversion of a PCM stream and associated location information (e.g., an audio object) into a source set of SHC is also contemplated.

The following expression shows an example of how a PCM object sᵢ(t), along with its metadata (containing location co-ordinates, etc.), may be transformed into a set of SHC:

$${s}_{i} ( t , {r}_{l} , {θ}_{l} , {ϕ}_{l} ) = {\sum }_{ω = 0}^{∞} [ {\sum }_{n = 0}^{∞} {j}_{n} ( k {r}_{l} ) {\sum }_{m = - n}^{n} {A}_{n}^{m} ( k ) {Y}_{n}^{m} ( {θ}_{l} , {ϕ}_{l} ) ] {e}^{j ω t} , \qquad ( 1 )$$

where

$$k = \frac{ω}{c} ,$$

c is the speed of sound (˜343 m/s), {rₗ, θₗ, φₗ} is a point of reference or observation point) within the sound field, jₙ (•) is the spherical Bessel function of order n, and Yₙ^{m} (θₗ, φₗ) are the spherical harmonic basis functions of order n and suborder m (some descriptions of SHC label n as degree (i.e. of the corresponding Legendre polynomial) and m as order). It can be recognized that the term in square brackets is a frequency-domain representation of the signal (i.e., S(ω,rₗ, θₗ, φₗ)) which can be approximated by various time-frequency transformations, such as the discrete Fourier transform (DFT), the discrete cosine transform (DCT), or a wavelet transform.

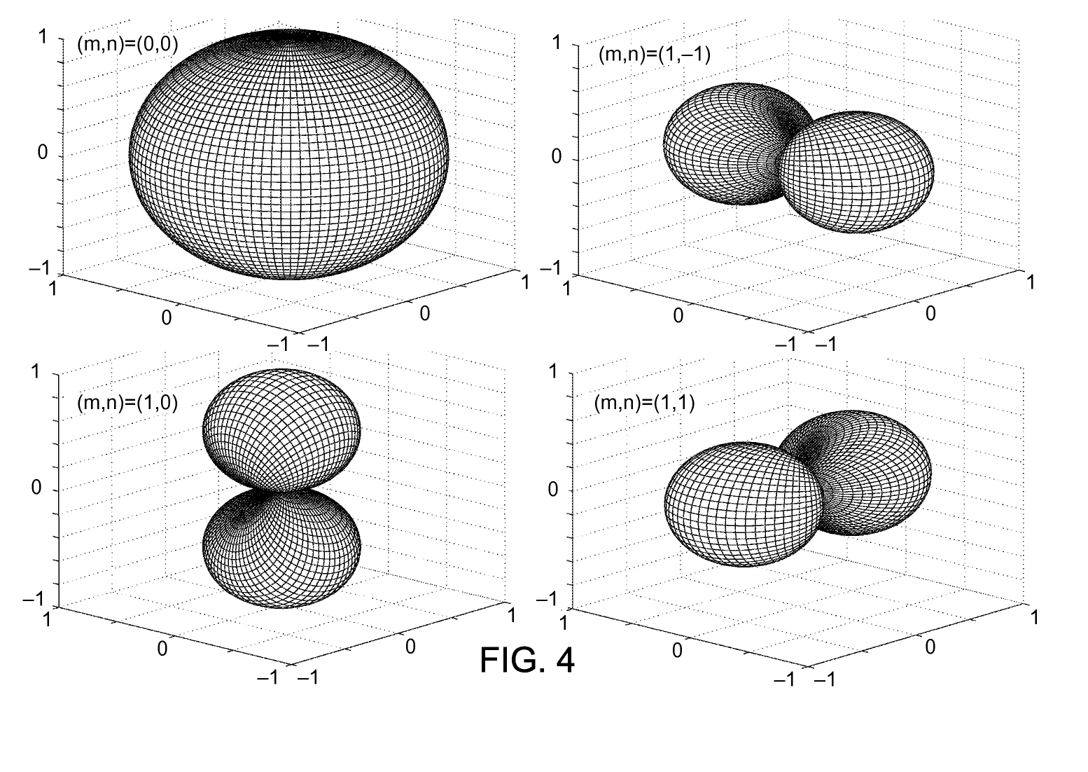

FIG. 4 shows examples of surface mesh plots of the magnitudes of spherical harmonic basis functions of degree 0 and 1. The magnitude of the function Y₀⁰ is spherical and omnidirectional. The function Y₁⁻¹ has positive and negative spherical lobes extending in the +y and −y directions, respectively. The function Y₁⁰ has positive and negative spherical lobes extending in the +z and −z directions, respectively. The function Y₁¹ has positive and negative spherical lobes extending in the +x and −x directions, respectively.

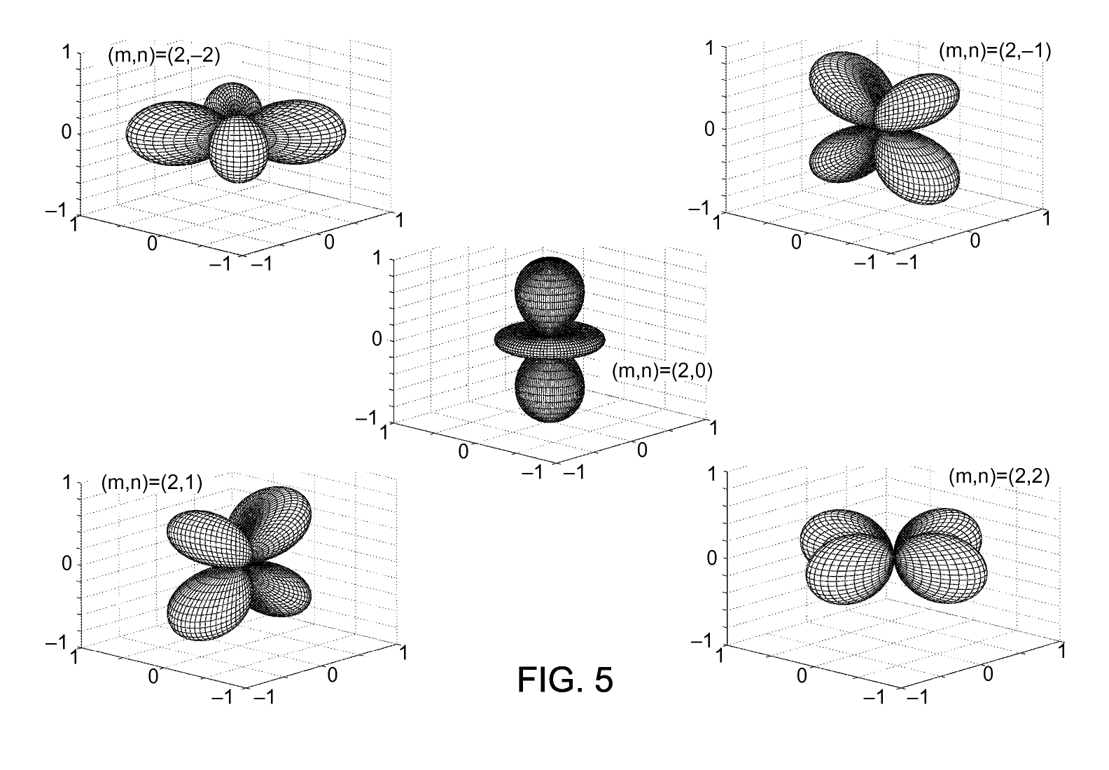

FIG. 5 shows examples of surface mesh plots of the magnitudes of spherical harmonic basis functions of degree 2. The functions Y₂⁻² and Y₂² have lobes extending in the x-y plane. The function Y₂⁻¹ has lobes extending in the y-z plane, and the function Y₂¹ has lobes extending in the x-z plane. The function Y₂⁰ has positive lobes extending in the +z and −z directions and a toroidal negative lobe extending in the x-y plane.

The total number of SHC in the set may depend on various factors. For scene-based audio, for example, the total number of SHC may be constrained by the number of microphone transducers in the recording array. For channel- and object-based audio, the total number of SHC may be determined by the available bandwidth. In one example, a fourth-order representation involving 25 coefficients (i.e., 0≦n≦4, −n≦m≦+n) for each frequency is used. Other examples of hierarchical sets that may be used with the approach described herein include sets of wavelet transform coefficients and other sets of coefficients of multiresolution basis functions.

A sound field may be represented in terms of SHC using an expression such as the following:

$${p}_{i} ( t , {r}_{l} , {θ}_{l} , {ϕ}_{l} ) = {\sum }_{ω = 0}^{∞} [ 4 π {\sum }_{n = 0}^{∞} {j}_{n} ( {kr}_{l} ) {\sum }_{m = - n}^{n} {A}_{n}^{m} ( k ) {Y}_{n}^{m} ( {θ}_{l} , {ϕ}_{l} ) ] {e}^{jω t} , \qquad ( 2 )$$

This expression shows that the pressure pᵢ at any point {r₁, θₗ, φₗ} of the sound field can be represented uniquely by the SHC Aₙ^{m} (k). The SHC Aₙ^{m} (k) can be derived from signals that are physically acquired (e.g., recorded) using any of various microphone array configurations, such as a tetrahedral or spherical microphone array. Input of this form represents scene-based audio input to a proposed encoder. In a non-limiting example, it is assumed that the inputs to the SHC encoder are the different output channels of a microphone array, such as an Eigenmike® (mh acoustics LLC, San Francisco, Calif.). One example of an Eigenmike® array is the em32 array, which includes 32 microphones arranged on the surface of a sphere of diameter 8.4 centimeters, such that each of the output signals pᵢ(t), i=1 to 32, is the pressure recorded at time sample t by microphone i.

Alternatively, the SHC Aₙ^{m} (k) can be derived from channel-based or object-based descriptions of the sound field. For example, the coefficients Aₙ^{m} (k) for the sound field corresponding to an individual audio object may be expressed as

Aₙ^{m}(k)=g(ω)(−4πik)hₙ⁽²⁾(krₛ)Yₙ^{m*}(θₛ,φₛ), (3)

where i is and \sqrt{−1} and hₙ²(•) is the spherical Hankel function (of the second kind) of order n, {rₛ, θₛ, φₛ} is the location of the object, and g(ω) is the source energy as a function of frequency. One of skill in the art will recognize that other representations of coefficients Aₙ^{m} (or, equivalently, of corresponding time-domain coefficients aₙ^{m}) may be used, such as representations that do not include the radial component.

Knowing the source energy g(ω) as a function of frequency allows us to convert each PCM object and its location {rₛ, θₛ, φₛ} into the SHC Aₙ^{m} (k). This source energy may be obtained, for example, using time-frequency analysis techniques, such as by performing a fast Fourier transform (e.g., a 256-, -512-, or 1024-point FFT) on the PCM stream. Further, it can be shown (since the above is a linear and orthogonal decomposition) that the Aₙ^{m}(k) coefficients for each object are additive. In this manner, a multitude of PCM objects can be represented by the Aₙ^{m}(k) coefficients (e.g., as a sum of the coefficient vectors for the individual objects). Essentially, these coefficients contain information about the sound field (the pressure as a function of 3D coordinates), and the above represents the transformation from individual objects to a representation of the overall sound field, in the vicinity of the observation point {rᵣ, θᵣ, φᵣ}.

One of skill in the art will recognize that several slightly different definitions of spherical harmonic basis functions are known (e.g., real, complex, normalized (e.g., N3D), semi-normalized (e.g., SN3D), Furse-Malham (FuMa or FMH), etc.), and consequently that expression (1) (i.e., spherical harmonic decomposition of a sound field) and expression (2) (i.e., spherical harmonic decomposition of a sound field produced by a point source) may appear in the literature in slightly different form. The present description is not limited to any particular form of the spherical harmonic basis functions and indeed is generally applicable to other hierarchical sets of elements as well.

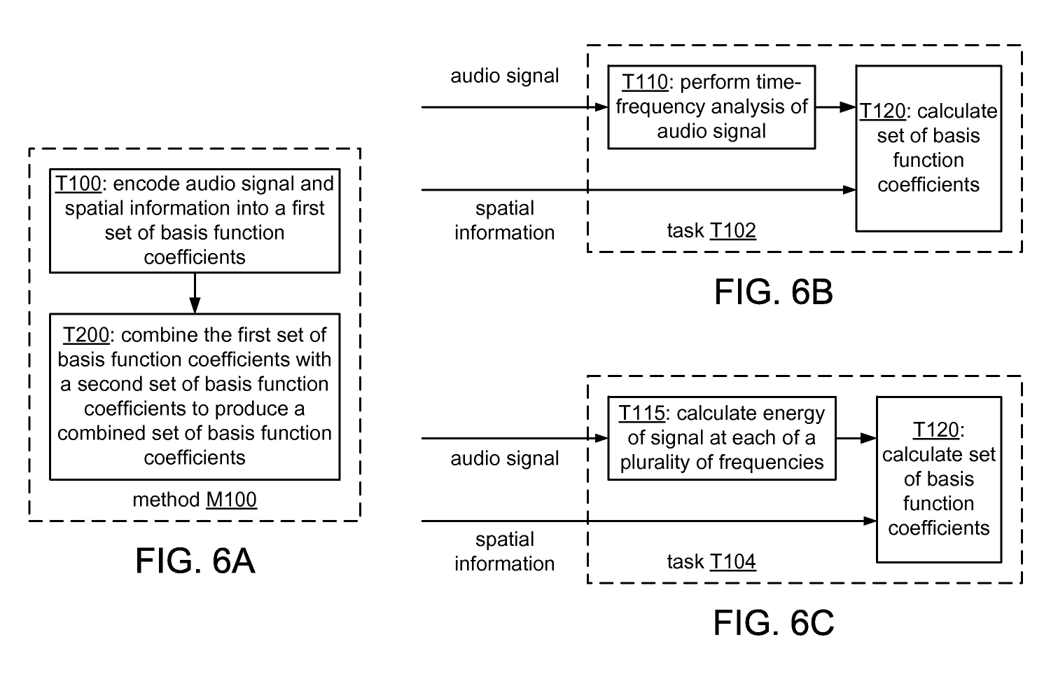

FIG. 6A shows a flowchart of a method M100 according to a general configuration that includes tasks T100 and T200. Task T100 encodes an audio signal (e.g., an audio stream of an audio object as described herein) and spatial information for the audio signal (e.g., from metadata of the audio object as described herein) into a first set of basis function coefficients that describes a first sound field. Task T200 combines the first set of basis function coefficients with a second set of basis function coefficients that describes a second sound field during a time interval (e.g., a set of SHC) to produce a combined set of basis function coefficients that describes a combined sound field during the time interval.

Task T100 may be implemented to perform a time-frequency analysis on the audio signal before calculating the coefficients. FIG. 6B shows a flowchart of such an implementation T102 of task T100 that includes subtasks T110 and T120. Task T110 performs a time-frequency analysis of the audio signal (e.g., a PCM stream). Based on the results of the analysis and on spatial information for the audio signal (e.g., location data, such as direction and/or distance), task T120 calculates the first set of basis function coefficients. FIG. 6C shows a flowchart of an implementation T104 of task T102 that includes an implementation T115 of task T110. Task T115 calculates an energy of the audio signal at each of a plurality of frequencies (e.g., as described herein with reference to source energy g(ω)). In such case, task T120 may be implemented to calculate the first set of coefficients as, for example, a set of spherical harmonic coefficients (e.g., according to an expression such as expression (3) above). It may be desirable to implement task T115 to calculate phase information of the audio signal at each of the plurality of frequencies and to implement task T120 to calculate the set of coefficients according to this information as well.

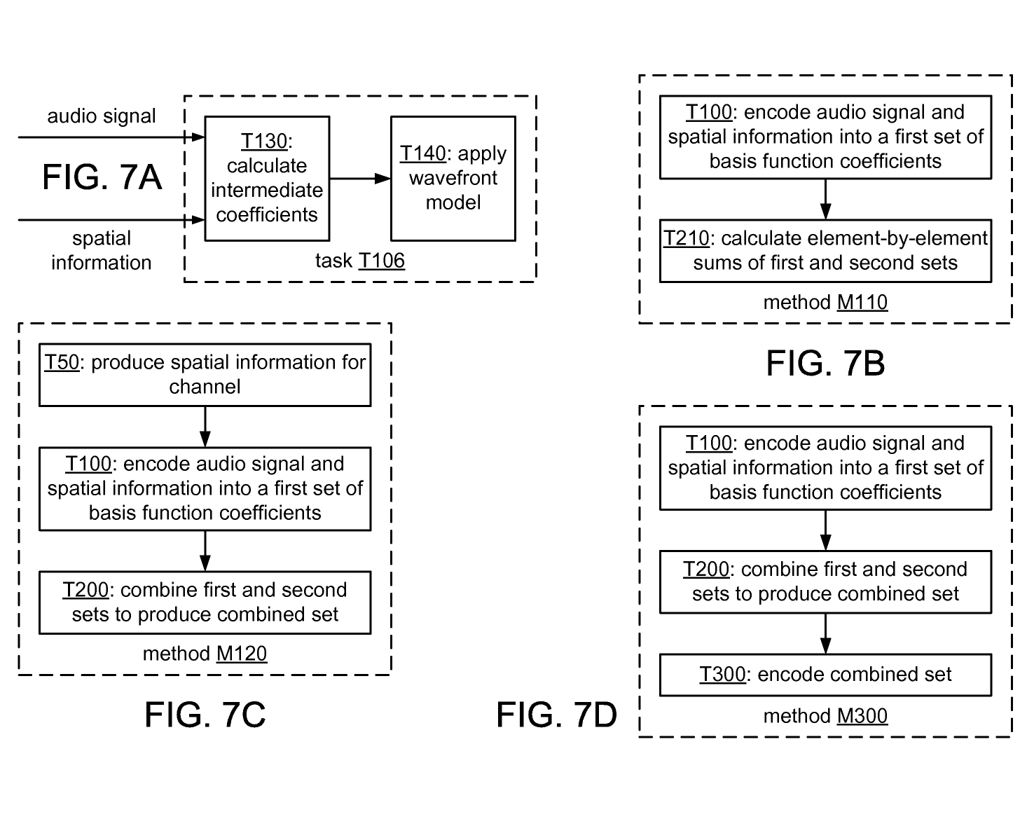

FIG. 7A shows a flowchart of an alternate implementation T106 of task T100 that includes subtasks T130 and T140. Task T130 performs an initial basis decomposition on the input signals to produce a set of intermediate coefficients. In one example, such a decomposition is expressed in the time domain as

Dₙ^{m}(t)= [symbol] pᵢ(t),Yₙ^{m}(θᵢ,φᵢ) [symbol] , (4)

where Dₙ^{m} denotes the intermediate coefficient for time sample t, order n, and suborder m; and Yₙ^{m} (θᵢ, φᵢ) denotes the spherical basis function, at order n and suborder m, for the elevation θᵢ and azimuth φᵢ associated with input stream i (e.g., the elevation and azimuth of the normal to the sound-sensing surface of a corresponding microphone i). In a particular but non-limiting example, the maximum N of order n is equal to four, such that a set of twenty-five intermediate coefficients D is obtained for each time sample t. It is expressly noted that task T130 may also be performed in a frequency domain.

Task T140 applies a wavefront model to the intermediate coefficients to produce the set of coefficients. In one example, task T140 filters the intermediate coefficients in accordance with a spherical-wavefront model to produce a set of spherical harmonic coefficients. Such an operation may be expressed as

aₙ^{m}(t)=Dₙ^{m}(t)*q_{s.n}(t), (5)

where aₙ^{m} (t) denotes the time-domain spherical harmonic coefficient at order n and suborder m for time sample t, q_{s.n}(t) denotes the time-domain impulse response of a filter for order n for the spherical-wavefront model, and * is the time-domain convolution operator. Each filter q_{s.n}(t), 1≦n≦N, may be implemented as a finite-impulse-response filter. In one example, each filter q_{s.n}(t) is implemented as an inverse Fourier transform of the frequency-domain filter

$$\frac{1}{{Q}_{s . n} ( ω )} , where {Q}_{s . n} ( ω ) = \frac{- i}{{( kr )}^{2} {h}_{n}^{( 2 ) ′} ( kr )} , \qquad ( 6 )$$

k is the wavenumber (ω/c), r is the radius of the spherical region of interest (e.g., the radius of the spherical microphone array), and hₙ⁽²⁾′ denotes the derivative (with respect to r) of the spherical Hankel function of the second kind of order n.

In another example, task T140 filters the intermediate coefficients in accordance with a planar-wavefront model to produce the set of spherical harmonic coefficients. For example, such an operation may be expressed as

bₙ^{m}(t)=Dₙ^{m}(t)*q_{p.n}(t), (7)

where bₙ^{m}(t) denotes the time-domain spherical harmonic coefficient at order n and suborder m for time sample t and q_{p.n}(t) denotes the time-domain impulse response of a filter for order n for the planar-wavefront model. Each filter q_{p.n} (t), 1≦n≦N, may be implemented as a finite-impulse-response filter. In one example, each filter q_{p.n}(t) is implemented as an inverse Fourier transform of the frequency-domain filter

$$\frac{1}{{Q}_{p . n} ( ω )} , where {Q}_{p . n} ( ω ) = \frac{( - 1 ) {i}^{n + 1}}{{( kr )}^{2} {h}_{n}^{( 2 ) ′} ( kr )} . \qquad ( 8 )$$

It is expressly noted that either of these examples of task T140 may also be performed in a frequency domain (e.g., as a multiplication).

FIG. 7B shows a flowchart of an implementation M110 of method M100 that includes an implementation T210 of task T200. Task T210 combines the first and second sets of coefficients by calculating element-by-element sums (e.g., a vector sum) to produce the combined set. In another implementation, task T200 is implemented to concatenate the first and second sets instead.

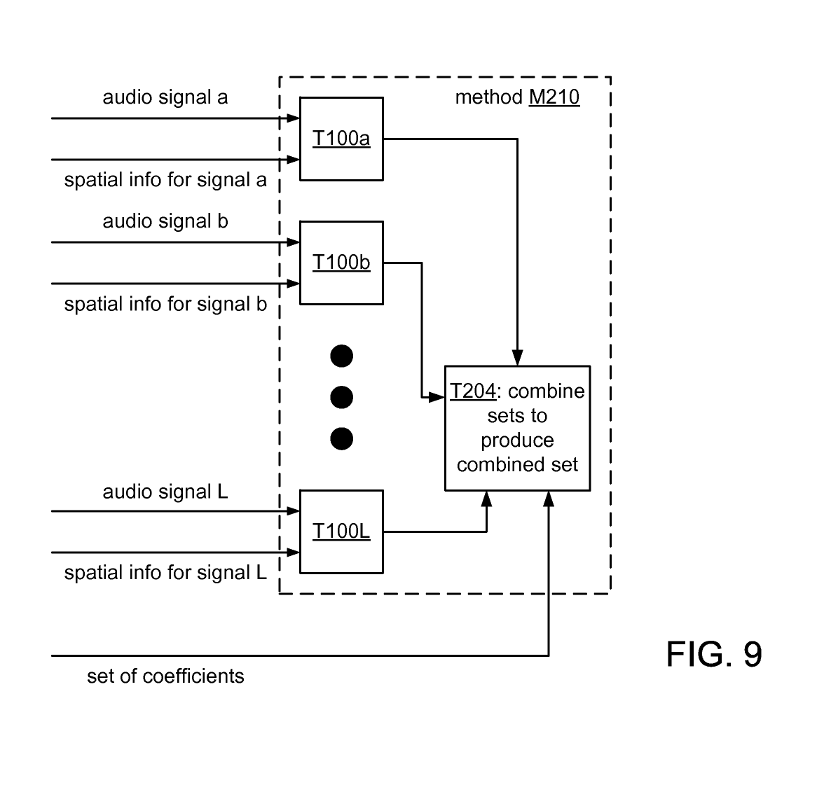

Task T200 may be arranged to combine the first set of coefficients, as produced by task T100, with a second set of coefficients as produced by another device or process (e.g., an Ambisonics or other SHC bitstream). Alternatively or additionally, task T200 may be arranged to combine sets of coefficients produced by multiple instances of task T100 (e.g., corresponding to each of two or more audio objects). Accordingly, it may be desirable to implement method M100 to include multiple instances of task T100. FIG. 8 shows a flowchart of such an implementation M200 of method M100 that includes L instances T100a-T100L of task T100 (e.g., of task T102, T104, or T106). Method M110 also includes an implementation T202 of task T200 (e.g., of task T210) that combines the L sets of basis function coefficients (e.g., as element-by-element sums) to produce a combined set. Method M110 may be used, for example, to encode a set of L audio objects (e.g., as illustrated in FIG. 1A) into a combined set of basis function coefficients (e.g., SHC). FIG. 9 shows a flowchart of an implementation M210 of method M200 that includes an implementation T204 of task T202, which combines the sets of coefficients produced by tasks T100a-T100L with a set of coefficients (e.g., SHC) as produced by another device or process.

It is contemplated and hereby disclosed that the sets of coefficients combined by task T200 need not have the same number of coefficients. To accommodate a case in which one of the sets is smaller than another, it may be desirable to implement task T210 to align the sets of coefficients at the lowest-order coefficient in the hierarchy (e.g., at the coefficient corresponding to the spherical harmonic basis function Y₀⁰).

The number of coefficients used to encode an audio signal (e.g., the number of the highest-order coefficient) may be different from one signal to another (e.g., from one audio object to another). For example, the sound field corresponding to one object may be encoded at a lower resolution than the sound field corresponding to another object. Such variation may be guided by factors that may include any one or more of, for example, the importance of the object to the presentation (e.g., a foreground voice vs. a background effect), location of the object relative to the listener's head (e.g., object to the side of the listener's head are less localizable than objects in front of the listener's head and thus may be encoded at a lower spatial resolution), and location of the object relative to the horizontal plane (e.g., the human auditory system has less localization ability outside this plane than within it, so that coefficients encoding information outside the plane may be less important than those encoding information within it).

In the context of unified spatial audio coding, channel-based signals (or loudspeaker feeds) are just audio signals (e.g., PCM feeds) in which the locations of the objects are the pre-determined positions of the loudspeakers. Thus channel-based audio can be treated as just a subset of object-based audio, in which the number of objects is fixed to the number of channels and the spatial information is implicit in the channel identification (e.g., L, C, R, Ls, Rs, LFE).

FIG. 7C shows a flowchart of an implementation M120 of method M100 that includes a task T50. Task T50 produces spatial information for a channel of a multichannel audio input. In this case, task T100 (e.g., task T102, T104, or T106) is arranged to receive the channel as the audio signal to be encoded with the spatial information. Task T50 may be implemented to produce the spatial information (e.g., the direction or location of a corresponding loudspeaker, relative to a reference direction or point) based on the format of the channel-based input. For a case in which only one channel format will be processed (e.g., only 5.1, or only 7.1), task T130 may be configured to produce a corresponding fixed direction or location for the channel. For a case in which multiple channel formats will be accommodated, task T130 may be implemented to produce the spatial information for the channel according to a format identifier (e.g., indicating 5.1, 7.1, or 22.2 format). The format identifier may be received as metadata, for example, or as an indication of the number of input PCM streams that are currently active.

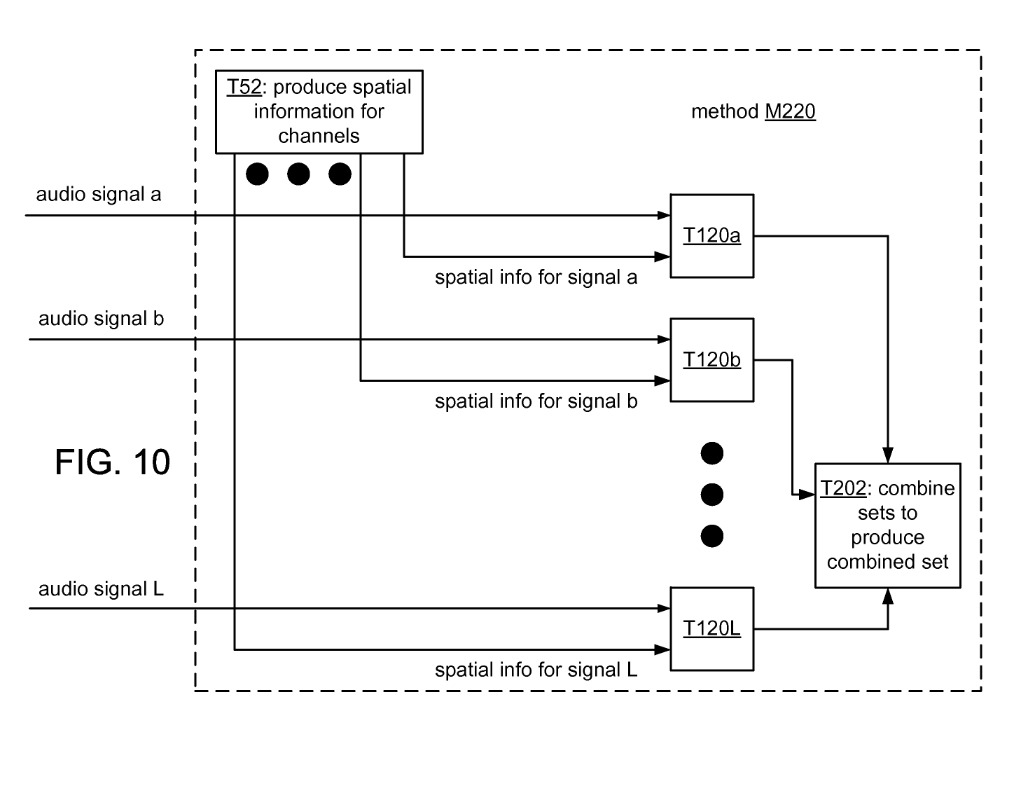

FIG. 10 shows a flowchart of an implementation M220 of method M200 that includes an implementation T52 of task T50, which produces spatial information for each channel (e.g., the direction or location of a corresponding loudspeaker), based on the format of the channel-based input, to encoding tasks T120a-T120L. For a case in which only one channel format will be processed (e.g., only 5.1, or only 7.1), task T52 may be configured to produce a corresponding fixed set of location data. For a case in which multiple channel formats will be accommodated, task T52 may be implemented to produce the location data for each channel according to a format identifier as described above. Method M220 may also be implemented such that task T202 is an instance of task T204.

In a further example, method M220 is implemented such that task T52 detects whether an audio input signal is channel-based or object-based (e.g., as indicated by a format of the input bitstream) and configures each of tasks T120a-L accordingly to use spatial information from task T52 (for channel-based input) or from the audio input (for object-based input). In another further example, a first instance of method M200 for processing object-based input and a second instance of method M200 (e.g., of M220) for processing channel-based input share a common instance of combining task T202 (or T204), such that the sets of coefficients calculated from the object-based and the channel-based inputs are combined (e.g., as a sum at each coefficient order) to produce the combined set of coefficients.

FIG. 7D shows a flowchart of an implementation M300 of method M100 that includes a task T300. Task T300 encodes the combined set (e.g., for transmission and/or storage). Such encoding may include bandwidth compression. Task T300 may be implemented to encode the set by applying one or more lossy or lossless coding techniques, such as quantization (e.g., into one or more codebook indices), error correction coding, redundancy coding, etc., and/or packetization. Additionally or alternatively, such encoding may include encoding into an Ambisonic format, such as B-format, G-format, or Higher-order Ambisonics (HOA). In one example, task T300 is implemented to encode the coefficients into HOA B-format and then to encode the B-format signals using Advanced Audio Coding (AAC; e.g., as defined in ISO/IEC 14496-3:2009, “Information technology—Coding of audio-visual objects—Part 3: Audio,” Int'l Org. for Standardization, Geneva, CH). Descriptions of other methods for encoding sets of SHC that may be performed by task T300 may be found, for example, in U.S. Publ. Pat. Appls. Nos. 2012/0155653 A1 (Jax et al.) and 2012/0314878 A1 (Daniel et al.). Task T300 may be implemented, for example, to encode the set of coefficients as differences between coefficients of different orders and/or differences between coefficients of the same order at different times.

Any of the implementations of methods M200, M210, and M220 as described herein may also be implemented as implementations of method M300 (e.g., to include an instance of task T300). It may be desirable to implement MPEG encoder MP10 as shown in FIG. 3B to perform an implementation of method M300 as described herein (e.g., to produce a bitstream for streaming, broadcast, multicast, and/or media mastering (for example, mastering of CD, DVD, and/or Blu-Ray® Disc)).

In another example, task T300 is implemented to perform a transform (e.g., using an invertible matrix) on a basic set of the combined set of coefficients to produce a plurality of channel signals, each associated with a corresponding different region of space (e.g., a corresponding different loudspeaker location). For example, task T300 may be implemented to apply an invertible matrix to convert a set of five low-order SHC (e.g., coefficients that correspond to basis functions that are concentrated in the 5.1 rendering plane, such as (m,n)=[(1,−1), (1,1), (2,−2), (2,2)], and the omnidirectional coefficient (m,n)=(0,0)) into the five full-band audio signals in the 5.1 format. The desire for invertibility is to allow conversion of the five full-band audio signals back to the basic set of SHC with little or no loss of resolution. Task T300 may be implemented to encode the resulting channel signals using a backward-compatible codec such as, for example, AC3 (e.g., as described in ATSC Standard: Digital Audio Compression, Doc. A/52:2012, 23 Mar. 2012, Advanced Television Systems Committee, Washington, D.C.; also called ATSC A/52 or Dolby Digital, which uses lossy MDCT compression), Dolby TrueHD (which includes lossy and lossless compression options), DTS-HD Master Audio (which also includes lossy and lossless compression options), and/or MPEG Surround (MPS, ISO/IEC 14496-3, also called High-Efficiency Advanced Audio Coding or HeAAC). The rest of the set of coefficients may be encoded into an extension portion of the bitstream (e.g., into “auxdata” portions of AC3 packets, or extension packets of a Dolby Digital Plus bitstream).

FIG. 8B shows a flowchart for a method M400 of decoding, according to a general configuration, that corresponds to method M300 and includes tasks T400 and T500. Task T400 decodes a bitstream (e.g., as encoded by task T300) to obtain a combined set of coefficients. Based on information relating to a loudspeaker array (e.g., indications of the number of the loudspeakers and their positions and radiation patterns), task T500 renders the coefficients to produce a set of loudspeaker channels. The loudspeaker array is driven according to the set of loudspeaker channels to produce a sound field as described by the combined set of coefficients.

One possible method for determining a matrix for rendering the SHC to a desired loudspeaker array geometry is an operation known as ‘mode-matching.’ Here, the loudspeaker feeds are computed by assuming that each loudspeaker produces a spherical wave. In such a scenario, the pressure (as a function of frequency) at a certain position r, θ, φ, due to the l-th loudspeaker, is given by

$${P}_{l} ( ω , r , θ , ϕ ) = {ℊ}_{l} ( ω ) {\sum }_{n = 0}^{∞} {j}_{n} ( kr ) {\sum }_{m = - n}^{n} ( - 4 π i k ) {h}_{n}^{( 2 )} ( {kr}_{l} ) {Y}_{n}^{{m}^{*}} ( {θ}_{l} , {ϕ}_{l} ) {Y}_{n}^{m} ( θ , ϕ ) , \qquad ( 9 )$$

where {r₁,θₗ,φₗ} represents the position of the f-th loudspeaker and gₗ(ω) is the loudspeaker feed of the l-th speaker (in the frequency domain). The total pressure Pₜ due to all L speakers is thus given by

$${P}_{t} ( ω , r , θ , ϕ ) = {\sum }_{l = 1}^{L} {ℊ}_{l} ( ω ) {\sum }_{n = 0}^{∞} {j}_{n} ( kr ) {\sum }_{m = - n}^{n} ( - 4 π i k ) {h}_{n}^{( 2 )} ( {kr}_{l} ) {Y}_{n}^{{m}^{*}} ( {θ}_{l} , {ϕ}_{l} ) {Y}_{n}^{m} ( θ , ϕ ) . \qquad ( 10 )$$

We also know that the total pressure in terms of the SHC is given by the equation

$${P}_{t} ( ω , r , θ , ϕ ) = 4 π {\sum }_{n = 0}^{∞} {j}_{n} ( kr ) {\sum }_{m = - n}^{n} {A}_{n}^{m} ( k ) {Y}_{n}^{m} ( θ , ϕ ) . \qquad ( 11 )$$

Equating the above two equations allows us to use a transform matrix to express the loudspeaker feeds in terms of the SHC as follows:

$$[ \begin{matrix}{A}_{0}^{0} ( ω ) \\ {A}_{1}^{1} ( ω ) \\ {A}_{1}^{- 1} ( ω ) \\ {A}_{2}^{2} ( ω ) \\ {A}_{2}^{- 2} ( ω )\end{matrix} ] = - ik [ \begin{matrix}{h}_{0}^{( 2 )} ( {kr}_{1} ) {Y}_{0}^{{0}^{*}} ( {θ}_{1} , {ϕ}_{1} ) & {h}_{0}^{( 2 )} ( {kr}_{2} ) {Y}_{0}^{{0}^{*}} ( {θ}_{2} , {ϕ}_{2} ) \cdot & … & … & … \\ {h}_{1}^{( 2 )} ( {kr}_{1} ) {Y}_{1}^{{1}^{*}} ( {θ}_{1} , {ϕ}_{1} ) \cdot & … & … & … & … \\ ⋮ & ⋮ & … & … & … \\ ⋮ & ⋮ & … & … & … \\ ⋮ & ⋮ & … & … & …\end{matrix} ] [ \begin{matrix}{ℊ}_{1} ( ω ) \\ {ℊ}_{2} ( ω ) \\ {ℊ}_{3} ( ω ) \\ {ℊ}_{4} ( ω ) \\ {ℊ}_{5} ( ω )\end{matrix} ] . \qquad ( 12 )$$

This expression shows that there is a direct relationship between the loudspeaker feeds and the chosen SHC. The transform matrix may vary depending on, for example, which coefficients were used and which definition of the spherical harmonic basis functions is used. Although for convenience this example shows a maximum N of order n equal to two, it is expressly noted that any other maximum order may be used as desired for the particular implementation (e.g., four or more). In a similar manner, a transform matrix to convert from a selected basic set to a different channel format (e.g., 7.1, 22.2) may be constructed. While the above transformation matrix was derived from a ‘mode matching’ criteria, alternative transform matrices can be derived from other criteria as well, such as pressure matching, energy matching, etc. Although expression (12) shows the use of complex basis functions (as demonstrated by the complex conjugates), use of a real-valued set of spherical harmonic basis functions instead is also expressly disclosed.

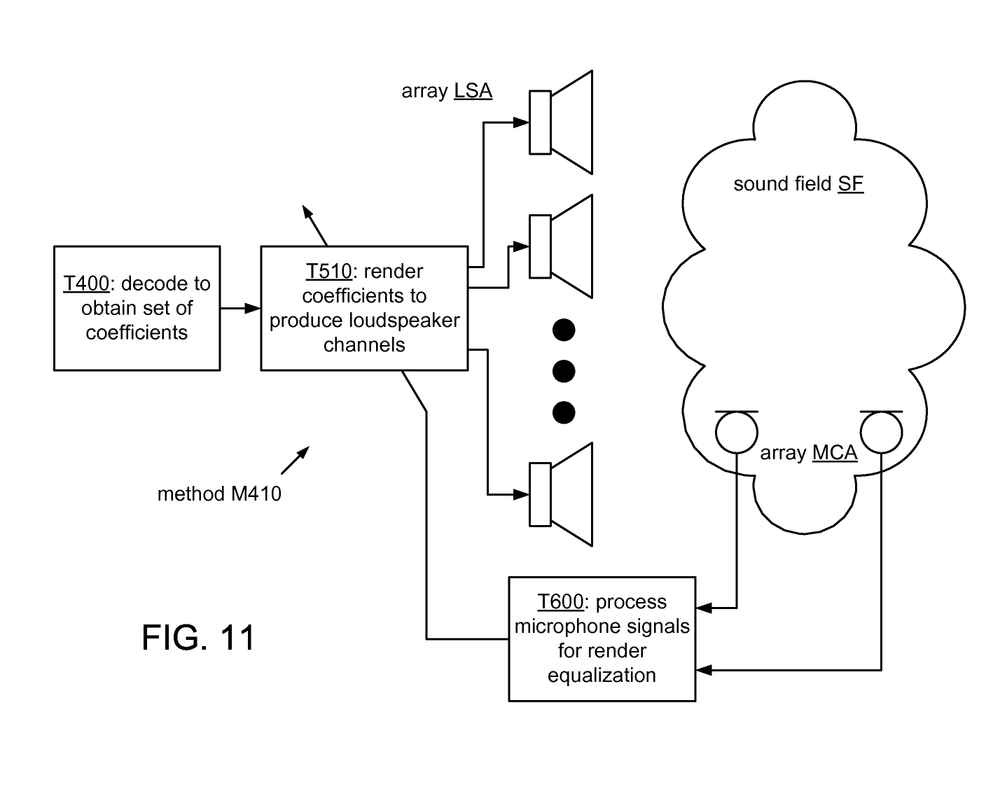

FIG. 11 shows a flowchart for an implementation M410 of method M400 that includes a task T600 and an adaptive implementation T510 of task T500. In this example, an array MCA of one or more microphones are arranged within the sound field SF produced by loudspeaker array LSA, and task T600 processes the signals produced by these microphones in response to the sound field to perform adaptive equalization of rendering task T510 (e.g., local equalization based on spatio-temporal measurements and/or other estimation techniques).

Potential advantages of such a representation using sets of coefficients of a set of orthogonal basis functions (e.g., SHC) include one or more of the following:

i. The coefficients are hierarchical. Thus, it is possible to send or store up to a certain truncated order (say n=N) to satisfy bandwidth or storage requirements. If more bandwidth becomes available, higher-order coefficients can be sent and/or stored. Sending more coefficients (of higher order) reduces the truncation error, allowing better-resolution rendering.

ii. The number of coefficients is independent of the number of objects—meaning that it is possible to code a truncated set of coefficients to meet the bandwidth requirement, no matter how many objects are in the sound-scene.

iii. The conversion of the PCM object to the SHC is not reversible (at least not trivially). This feature may allay fears from content providers who are concerned about allowing undistorted access to their copyrighted audio snippets (special effects), etc.

iv. Effects of room reflections, ambient/diffuse sound, radiation patterns, and other acoustic features can all be incorporated into the Aₙ^{m}(k) coefficient-based representation in various ways.

v. The Aₙ^{m}(k) coefficient-based sound field/surround-sound representation is not tied to particular loudspeaker geometries, and the rendering can be adapted to any loudspeaker geometry. Various additional rendering technique options can be found in the literature, for example.

vi. The SHC representation and framework allows for adaptive and non-adaptive equalization to account for acoustic spatio-temporal characteristics at the rendering scene (e.g., see method M410).

An approach as described herein may be used to provide a transformation path for channel- and/or object-based audio that allows a unified encoding/decoding engine for all three formats: channel-, scene-, and object-based audio. Such an approach may be implemented such that the number of transformed coefficients is independent of the number of objects or channels. Such an approach can also be used for either channel- or object-based audio even when an unified approach is not adopted. The format may be implemented to be scalable in that the number of coefficients can be adapted to the available bit-rate, allowing a very easy way to trade-off quality with available bandwidth and/or storage capacity.

The SHC representation can be manipulated by sending more coefficients that represent the horizontal acoustic information (for example, to account for the fact that human hearing has more acuity in the horizontal plane than the elevation/height plane). The position of the listener's head can be used as feedback to both the renderer and the encoder (if such a feedback path is available) to optimize the perception of the listener (e.g., to account for the fact that humans have better spatial acuity in the frontal plane). The SHC may be coded to account for human perception (psychoacoustics), redundancy, etc. As shown in method M410, for example, an approach as described herein may be implemented as an end-to-end solution (including final equalization in the vicinity of the listener) using, e.g., spherical harmonics.

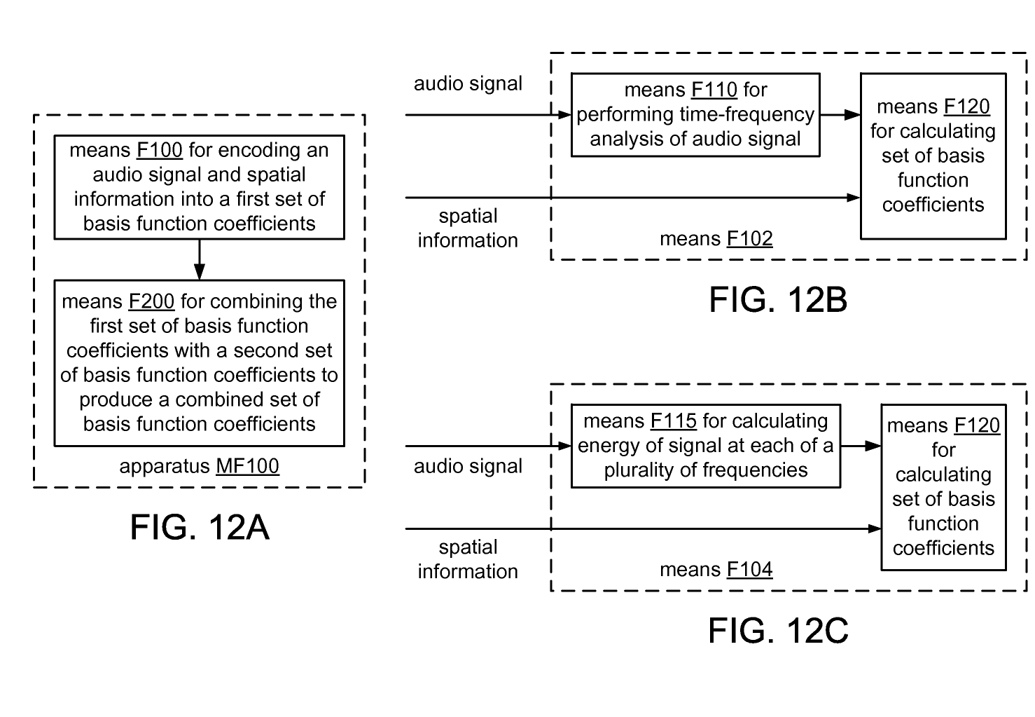

FIG. 12A shows a block diagram of an apparatus MF100 according to a general configuration. Apparatus MF100 includes means F100 for encoding an audio signal and spatial information for the audio signal into a first set of basis function coefficients that describes a first sound field (e.g., as described herein with reference to implementations of task T100). Apparatus MF100 also includes means F200 for combining the first set of basis function coefficients with a second set of basis function coefficients that describes a second sound field during a time interval to produce a combined set of basis function coefficients that describes a combined sound field during the time interval (e.g., as described herein with reference to implementations of task T100).

FIG. 12B shows a block diagram of an implementation F102 of means F100. Means F102 includes means F110 for performing time-frequency analysis of the audio signal (e.g., as described herein with reference to implementations of task T110). Means F102 also includes means F120 for calculating the set of basis function coefficients (e.g., as described herein with reference to implementations of task T120). FIG. 12C shows a block diagram of an implementation F104 of means F102 in which means F110 is implemented as means F115 for calculating energy of the audio signal at each of a plurality of frequencies (e.g., as described herein with reference to implementations of task T115).

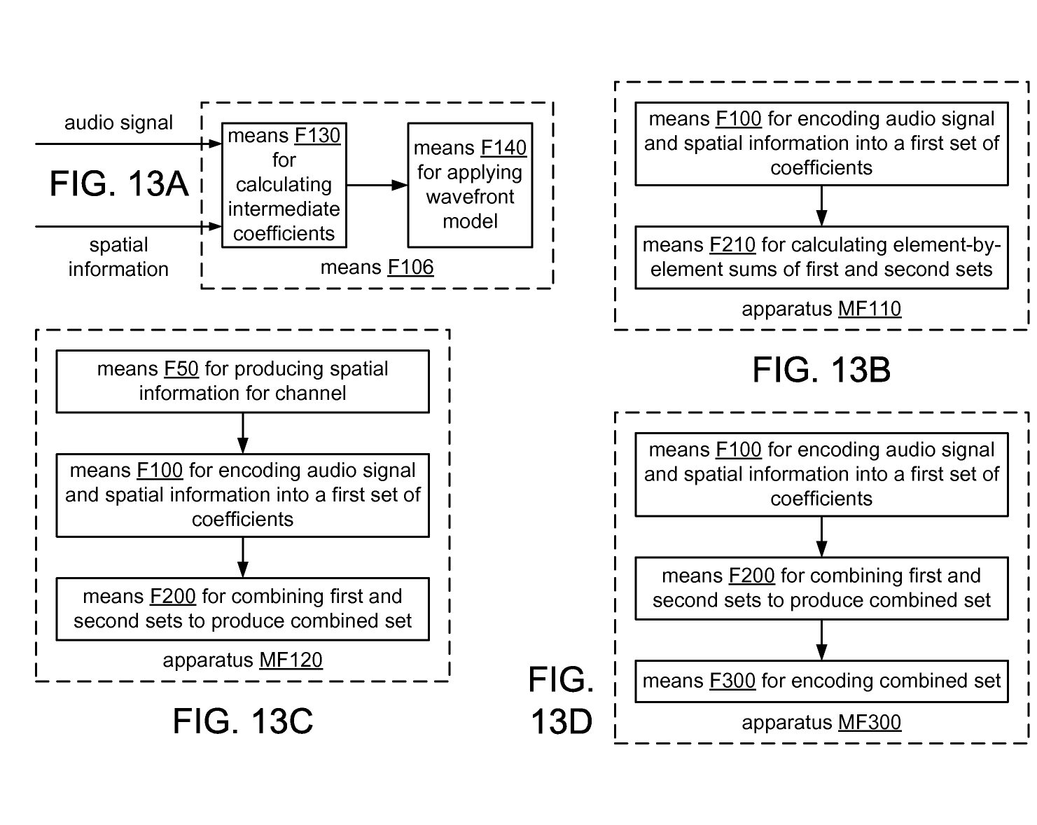

FIG. 13A shows a block diagram of an implementation F106 of means F100. Means F106 includes means F130 for calculating intermediate coefficients (e.g., as described herein with reference to implementations of task T130). Means F106 also includes means F140 for applying a wavefront model to the intermediate coefficients (e.g., as described herein with reference to implementations of task T140).

FIG. 13B shows a block diagram of an implementation MF110 of apparatus MF100 in which means F200 is implemented as means F210 for calculating element-by-element sums of the first and second sets of basis function coefficients (e.g., as described herein with reference to implementations of task T210).

FIG. 13C shows a block diagram of an implementation MF120 of apparatus MF100. Apparatus MF120 includes means F50 for producing spatial information for a channel of a multichannel audio input (e.g., as described herein with reference to implementations of task T50).

FIG. 13D shows a block diagram of an implementation MF300 of apparatus MF100. Apparatus MF300 includes means F300 for encoding the combined set of basis function coefficients (e.g., as described herein with reference to implementations of task T300). Apparatus MF300 may also be implemented to include an instance of means F50.

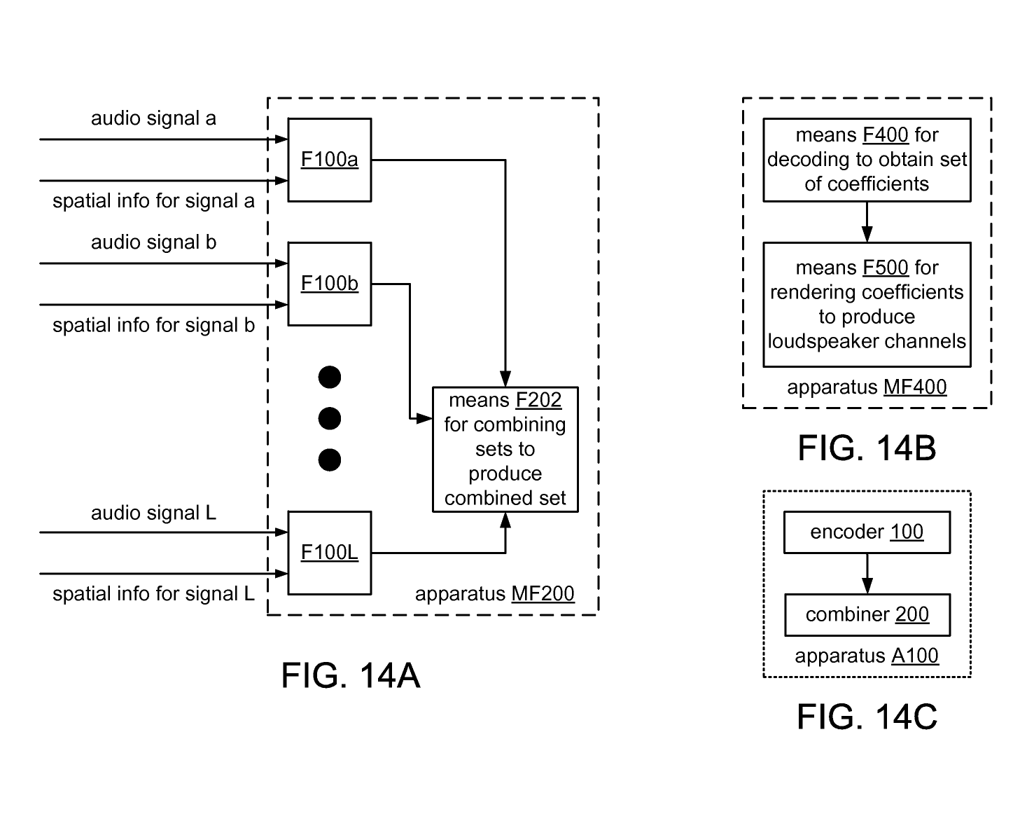

FIG. 14A shows a block diagram of an implementation MF200 of apparatus MF100. Apparatus MF200 includes multiple instances F100a-F100L of means F100 and an implementation F202 of means F200 for combining sets of basis function coefficients produced by means F100a-F100L (e.g., as described herein with reference to implementations of method M200 and task T202).

FIG. 14B shows a block diagram of an apparatus MF400 according to a general configuration. Apparatus MF400 includes means F400 for decoding a bitstream to obtain a combined set of basis function coefficients (e.g., as described herein with reference to implementations of task T400). Apparatus MF400 also includes means F500 for rendering coefficients of the combined set to produce a set of loudspeaker channels (e.g., as described herein with reference to implementations of task T500).

FIG. 14C shows a block diagram of an apparatus A100 according to a general configuration. Apparatus A100 includes an encoder 100 configured to encode an audio signal and spatial information for the audio signal into a first set of basis function coefficients that describes a first sound field (e.g., as described herein with reference to implementations of task T100). Apparatus A100 also includes a combiner 200 configured to combine the first set of basis function coefficients with a second set of basis function coefficients that describes a second sound field during a time interval to produce a combined set of basis function coefficients that describes a combined sound field during the time interval (e.g., as described herein with reference to implementations of task T100).

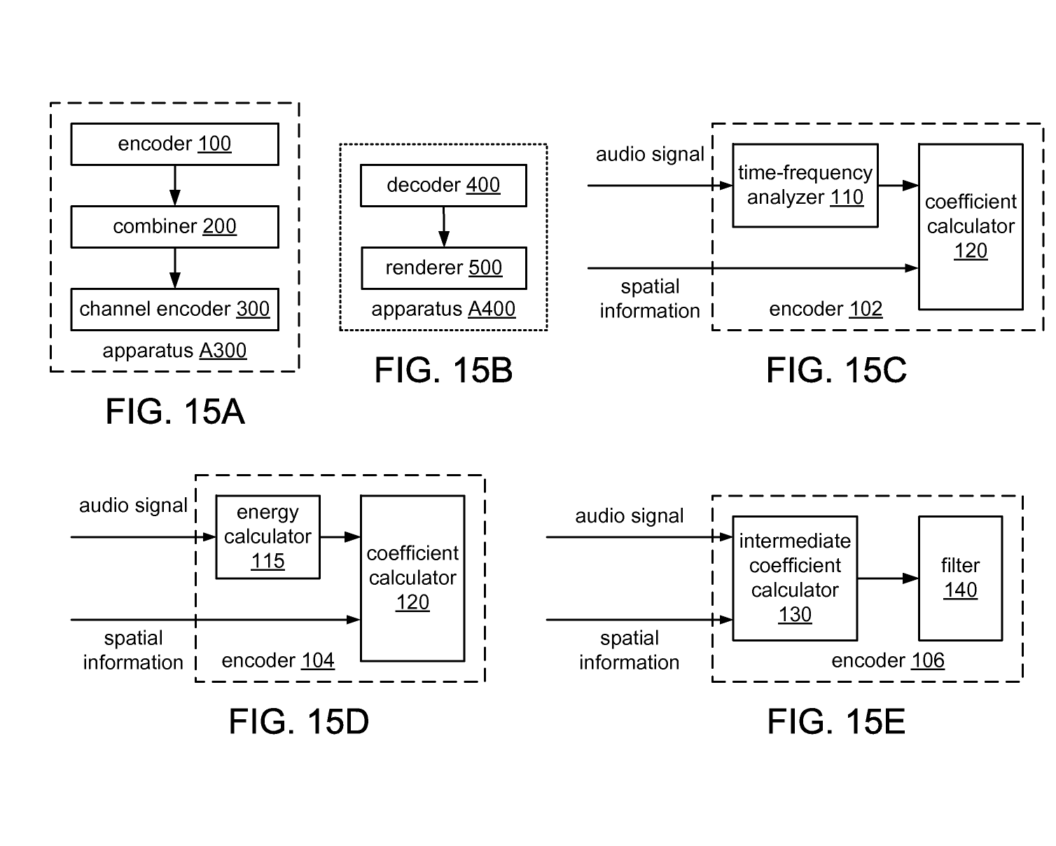

FIG. 15A shows a block diagram of an implementation A300 of apparatus A100. Apparatus A300 includes a channel encoder 300 configured to encode the combined set of basis function coefficients (e.g., as described herein with reference to implementations of task T300). Apparatus A300 may also be implemented to include an instance of angle indicator 50 as described below.

FIG. 15B shows a block diagram of an apparatus MF400 according to a general configuration. Apparatus MF400 includes means F400 for decoding a bitstream to obtain a combined set of basis function coefficients (e.g., as described herein with reference to implementations of task T400). Apparatus MF400 also includes means F500 for rendering coefficients of the combined set to produce a set of loudspeaker channels (e.g., as described herein with reference to implementations of task T500).

FIG. 15C shows a block diagram of an implementation 102 of encoder 100. Encoder 102 includes a time-frequency analyzer 110 configured to perform time-frequency analysis of the audio signal (e.g., as described herein with reference to implementations of task T110). Encoder 102 also includes a coefficient calculator 120 configured to calculate the set of basis function coefficients (e.g., as described herein with reference to implementations of task T120). FIG. 15D shows a block diagram of an implementation 104 of encoder 102 in which analyzer 110 is implemented as an energy calculator 115 configured to calculate energy of the audio signal at each of a plurality of frequencies (e.g., by performing a fast Fourier transform on the signal, as described herein with reference to implementations of task T115).

FIG. 15E shows a block diagram of an implementation 106 of encoder 100. Encoder 106 includes an intermediate coefficient calculator 130 configured to calculate intermediate coefficients (e.g., as described herein with reference to implementations of task T130). Encoder 106 also includes a filter 140 configured to apply a wavefront model to the intermediate coefficients to produce the first set of basis function coefficients (e.g., as described herein with reference to implementations of task T140).

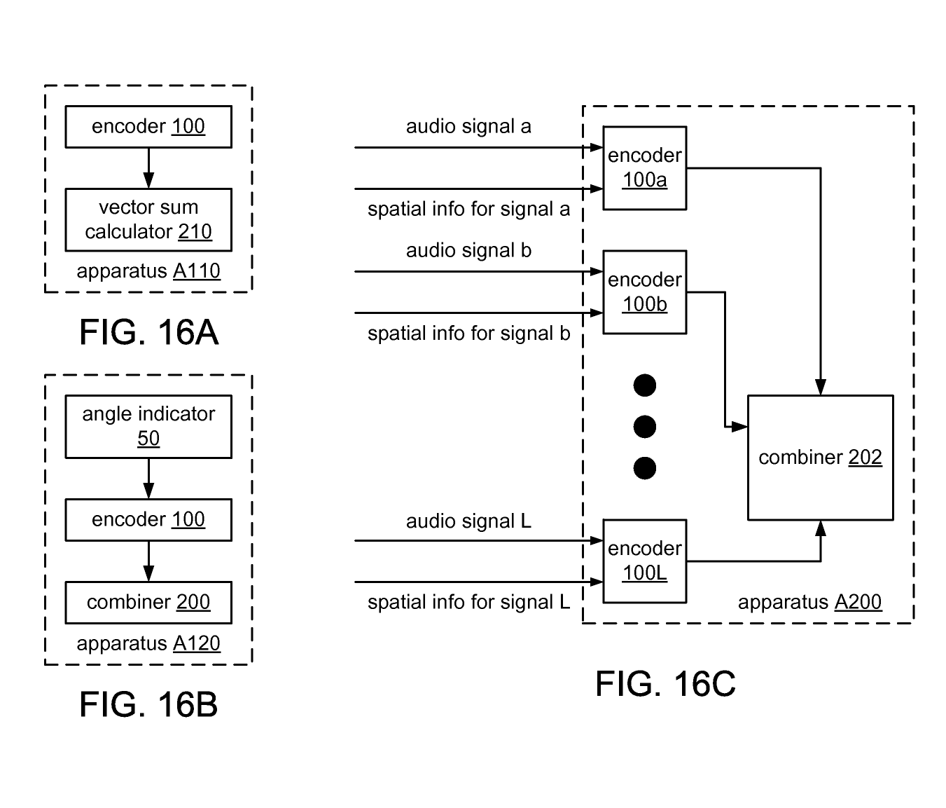

FIG. 16A shows a block diagram of an implementation A110 of apparatus A100 in which combiner 200 is implemented as a vector sum calculator 210 configured to calculate element-by-element sums of the first and second sets of basis function coefficients (e.g., as described herein with reference to implementations of task T210).

FIG. 16B shows a block diagram of an implementation A120 of apparatus A100. Apparatus A120 includes an angle indicator 50 configured to produce spatial information for a channel of a multichannel audio input (e.g., as described herein with reference to implementations of task T50).

FIG. 16C shows a block diagram of an implementation A200 of apparatus A100. Apparatus A200 includes multiple instances 100a-100L of encoder 100 and an implementation 202 of combiner 200 configured to combine sets of basis function coefficients produced by encoders 100a-100L (e.g., as described herein with reference to implementations of method M200 and task T202). Apparatus A200 may also include a channel location data producer configured to produce corresponding location data for each stream, if the input is channel-based, according to an input format which may be predetermined or indicated by a format identifier, as described above with reference to task T52.

Each of encoders 100a-100L may be configured to calculate a set of SHC for a corresponding input audio signal (e.g., PCM stream), based on spatial information (e.g., location data) for the signal as provided by metadata (for object-based input) or a channel location data producer (for channel-based input), as described above with reference to tasks T100a-T100L and T120a-T120L. Combiner 202 is configured to calculate a sum of the sets of SHC to produce a combined set, as described above with reference to task T202. Apparatus A200 may also include an instance of encoder 300 configured to encode the combined set of SHC, as received from combiner 202 (for object-based and channel-based inputs) and/or from a scene-based input, into a common format for transmission and/or storage, as described above with reference to task T300.

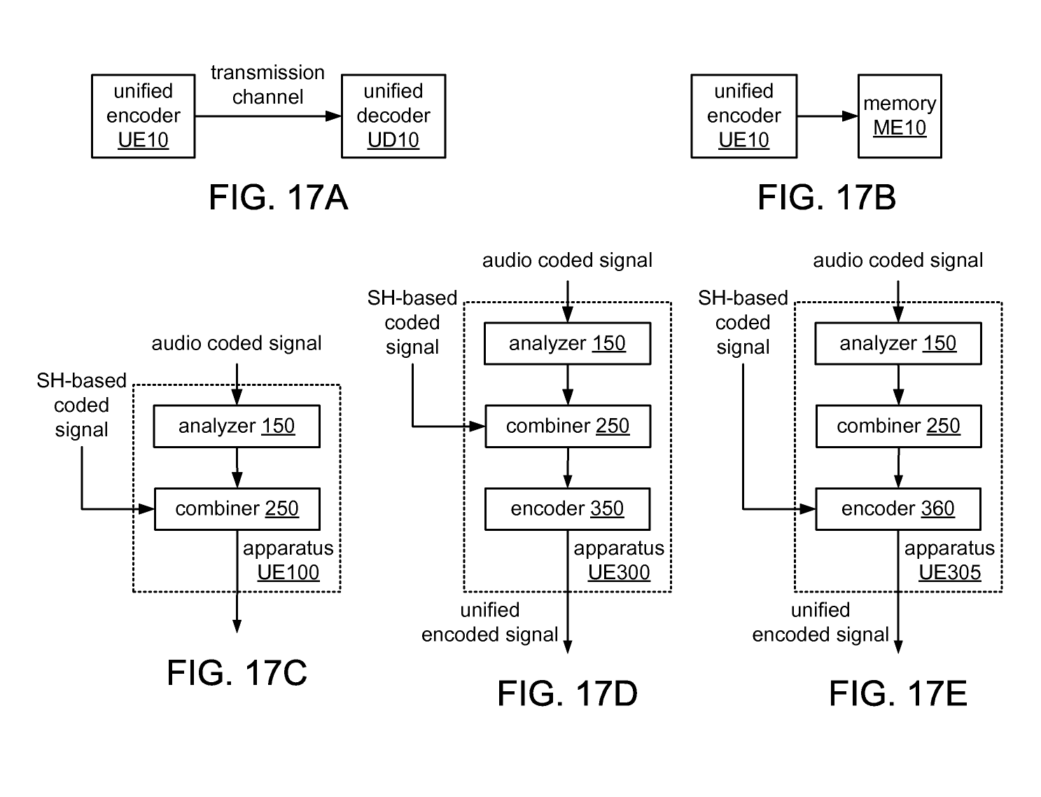

FIG. 17A shows a block diagram for a unified coding architecture. This unified coding architecture may be deployed in or otherwise included in any number of systems, such as one or more of a home theater system, a decoding system, a transportation system (e.g., an entertainment system of a bus, car, plane, or the like,), and a broadcasting equipment system.

In this example, a unified encoder UE10 is configured to produce a unified encoded signal and to transmit the unified encoded signal via a transmission channel to a unified decoder UD10. Unified encoder UE10 may be implemented as described herein to produce the unified encoded signal from channel-based, object-based, and/or scene-based (e.g., SHC-based) inputs.

FIG. 17B shows a block diagram for a related architecture in which unified encoder UE10 is configured to store the unified encoded signal to a memory ME10. Again, this architecture may be deployed in or otherwise included in any number of systems, such as one or more of a home theater system, a decoding system, a transportation system (e.g., an entertainment system of a bus, car, plane, or the like,), and a broadcasting equipment system.

FIG. 17C shows a block diagram of an implementation UE100 of unified encoder UE10 and apparatus A100 that includes an implementation 150 of encoder 100 as a spherical harmonic (SH) analyzer and an implementation 250 of combiner 200. As noted above, this implementation may be deployed in or otherwise included in any number of systems, such as one or more of a home theater system, a decoding system, a transportation system (e.g., an entertainment system of a bus, care, plane, or the like), and a broadcasting equipment system.

Analyzer 150 is configured to produce an SH-based coded signal based on audio and location information encoded in the input audio coded signal (e.g., as described herein with reference to task T100). The input audio coded signal may be, for example, a channel-based or object-based input. Combiner 250 is configured to produce a sum of the SH-based coded signal produced by analyzer 150 and another SH-based coded signal (e.g., a scene-based input).

FIG. 17D shows a block diagram of an implementation UE300 of unified encoder UE100 and apparatus A300 that may be used for processing object-based, channel-based, and scene-based inputs into a common format for transmission and/or storage. As noted above, this implementation may be deployed in or otherwise included in any number of systems, such as one or more of a home theater system, a decoding system, a transportation system (e.g., an entertainment system of a bus, car, plane, or the like,), and a broadcasting equipment system. Encoder UE300 includes an implementation 350 of encoder 300 (e.g., a unified coefficient set encoder). Unified coefficient set encoder 350 is configured to encode the summed signal (e.g., as described herein with reference to coefficient set encoder 300) to produce a unified encoded signal. As a scene-based input may already be encoded in SHC form, it may be sufficient for the unified encoder to process the input (e.g., by quantization, error correction coding, redundancy coding, etc., and/or packetization) into a common format for transfer and/or storage.

FIG. 17E shows a block diagram of such an implementation UE305 of unified encoder UE100 in which an implementation 360 of encoder 300 is arranged to encode the other SH-based coded signal (e.g., in case no such signal is available from combiner 250). As noted above, this implementation may be deployed in or otherwise included in any number of systems, such as one or more of a home theater system, a decoding system, a transportation system (e.g., an entertainment system of a bus, car, plane, or the like,), and a broadcasting equipment system.

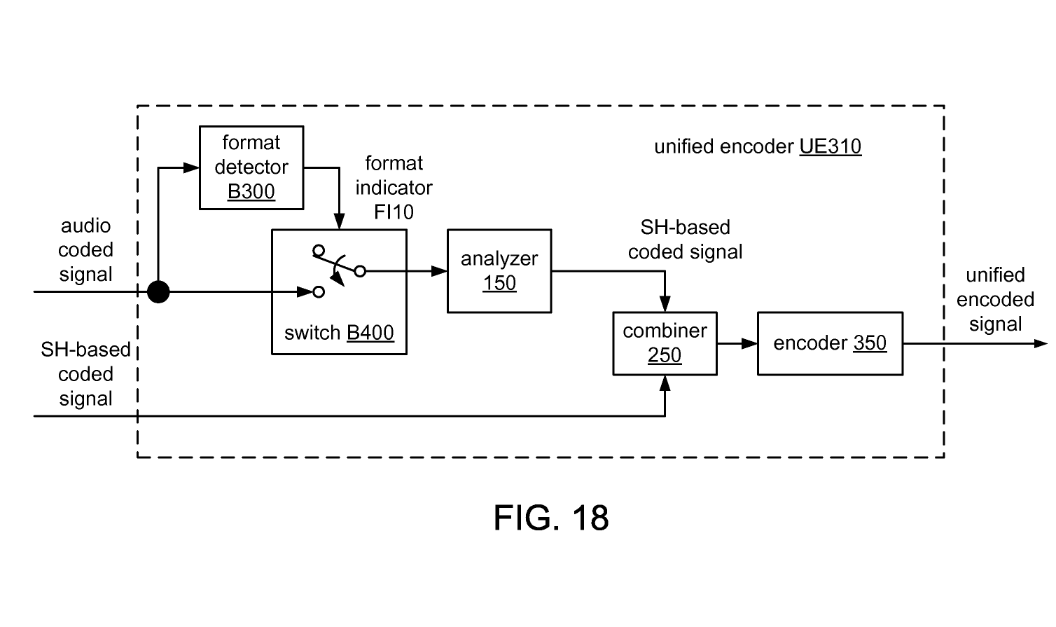

FIG. 18 shows a block diagram of an implementation UE310 of unified encoder UE10 that includes a format detector B300 configured to produce a format indicator FI10 based on information in the audio coded signal, and a switch B400 that is configured to enable or disable input of the audio coded signal to analyzer 150, according to the state of the format indicator. Again, this architecture may be deployed in or otherwise included in any number of systems, such as one or more of a home theater system, a decoding system, a transportation system (an entertainment system of a bus, car, plane, or the like,), and a broadcasting equipment system.

Format detector B300 may be implemented, for example, such that format indicator FI10 has a first state when the audio coded signal is a channel-based input and a second state when the audio coded signal is an object-based input. Additionally or alternatively, format detector B300 may be implemented to indicate a particular format of a channel-based input (e.g., to indicate that the input is in a 5.1, 7.1, or 22.2 format).

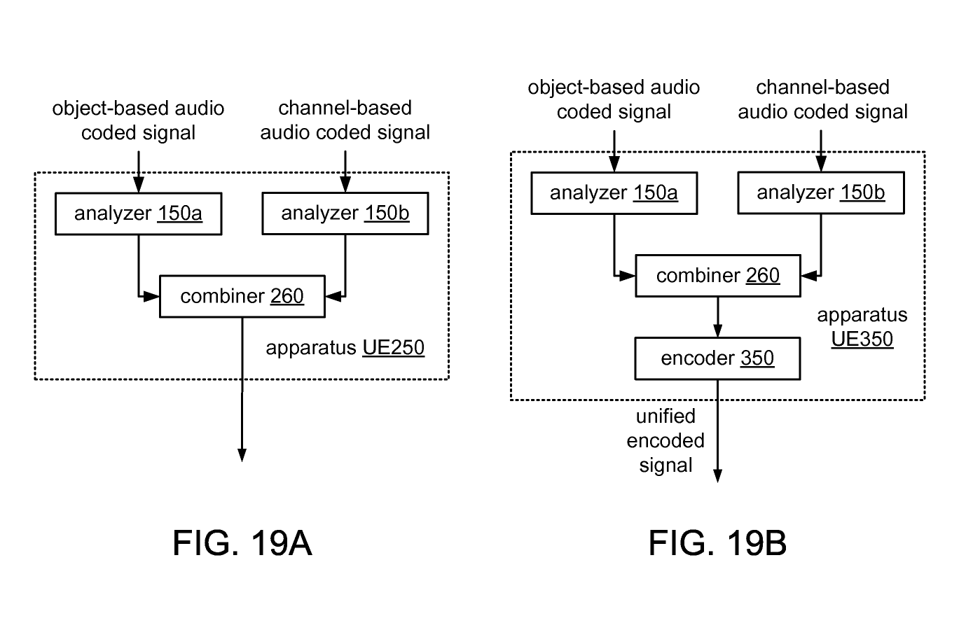

FIG. 19A shows a block diagram of an implementation UE250 of unified encoder UE100 that includes a first implementation 150a of analyzer 150 which is configured to encode a channel-based audio coded signal into a first SH-based coded signal. Unified encoder UE250 also includes a second implementation 150b of analyzer 150 which is configured to encode an object-based audio coded signal into a second SH-based coded signal. In this example, an implementation 260 of combiner 250 is arranged to produce a sum of the first and second SH-based coded signals.

FIG. 19B shows a block diagram of an implementation UE350 of unified encoder UE250 and UE300 in which encoder 350 is arranged to produce the unified encoded signal by encoding the sum of the first and second SH-based coded signals produced by combiner 260.

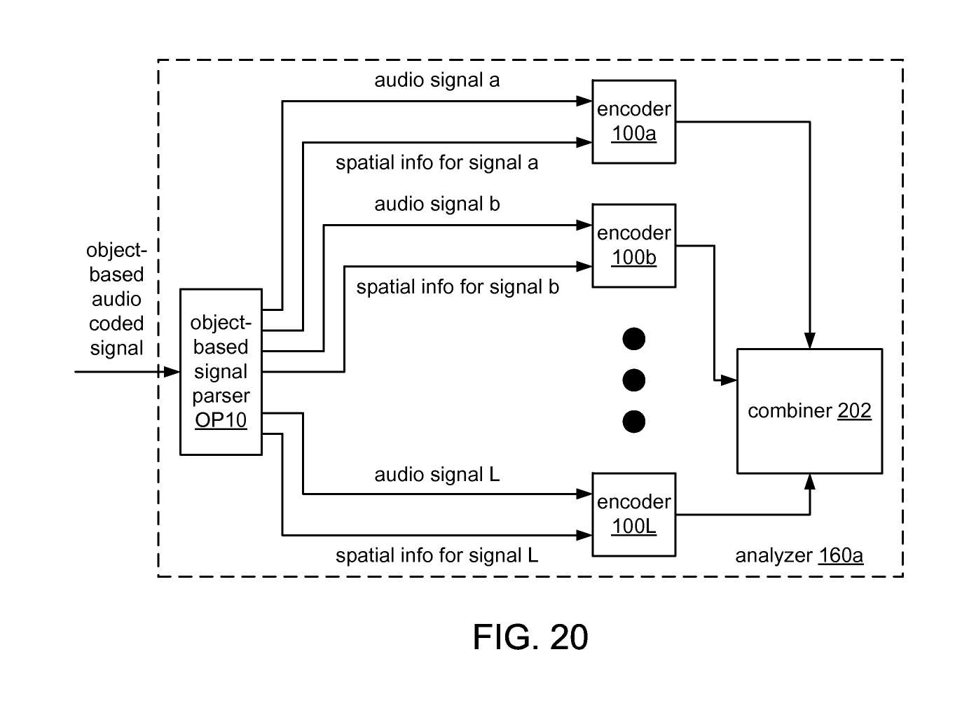

FIG. 20 shows a block diagram of an implementation 160a of analyzer 150a that includes an object-based signal parser OP10. Parser OP10 may be configured to parse the object-based input into its various component objects as PCM streams and to decode the associated metadata into location data for each object. The other elements of analyzer 160a may be implemented as described herein with reference to apparatus A200.

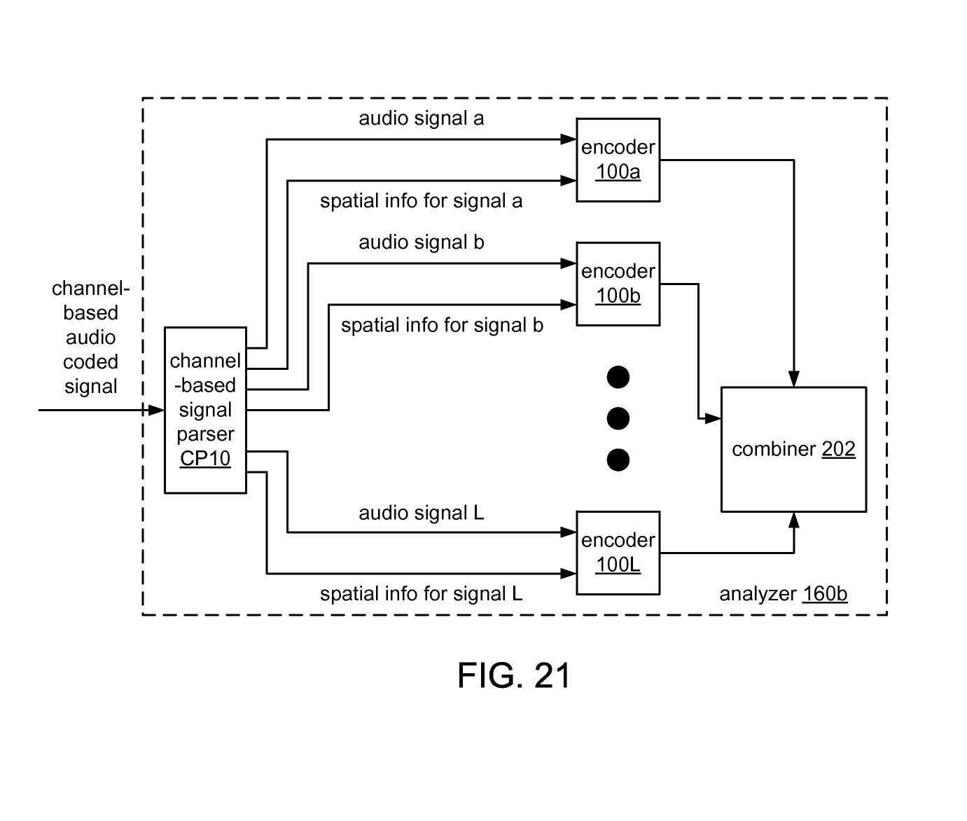

FIG. 21 shows a block diagram of an implementation 160b of analyzer 150b that includes a channel-based signal parser CP10. Parser CP10 may be implemented to include an instance of angle indicator 50 as described herein. Parser CP10 may also be configured to parse the channel-based input into its various component channels as PCM streams. The other elements of analyzer 160b may be implemented as described herein with reference to apparatus A200.

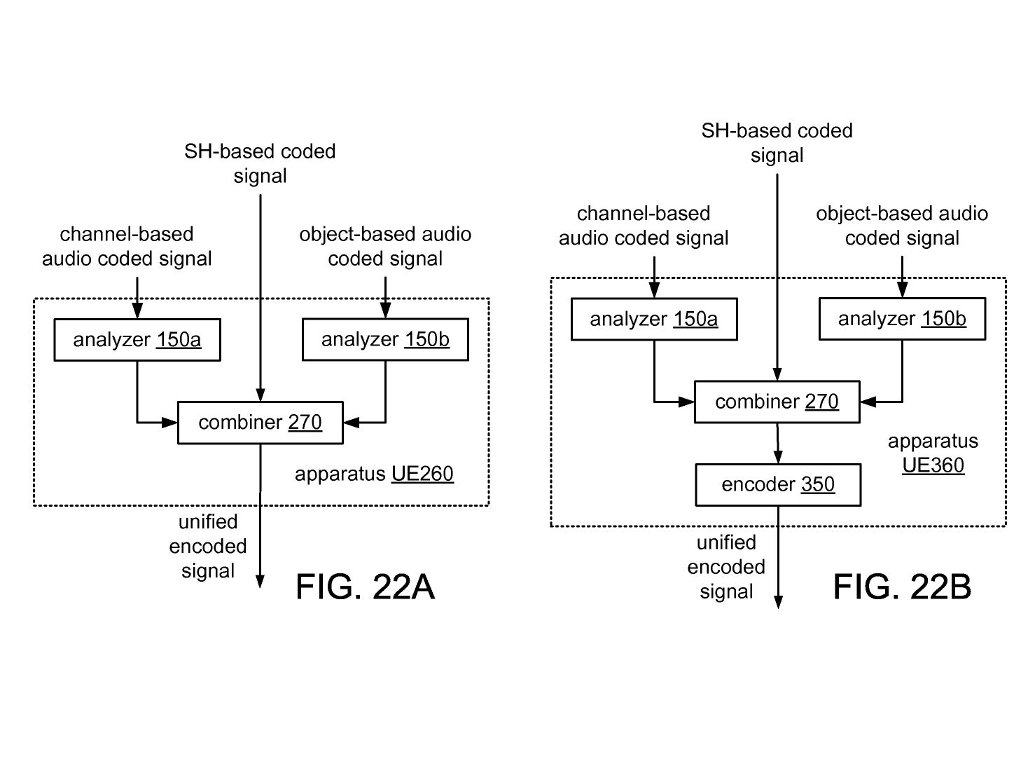

FIG. 22A shows a block diagram of an implementation UE260 of unified encoder UE250 that includes an implementation 270 of combiner 260, which is configured to produce a sum of the first and second SH-based coded signals and an input SH-based coded signal (e.g., a scene-based input). FIG. 22B shows a block diagram of a similar implementation UE360 of unified encoder UE350.

It may be desirable to implement MPEG encoder MP10 as shown in FIG. 3B as an implementation of unified encoder UE10 as described herein (e.g., UE100, UE250, UE260, UE300, UE310, UE350, UE360) to produce, for example, a bitstream for streaming, broadcast, multicast, and/or media mastering (for example, mastering of CD, DVD, and/or Blu-Ray® Disc)). In another example, one or more audio signals may be coded for transmission and/or storage simultaneously with SHC (e.g., obtained in a manner as described above).

Traditional methods of SHC-based coding (e.g., higher-order Ambisonics or HOA) typically use a plane-wave approximation to model the sound field to be encoded. Such an approximation assumes that the sources which give rise to the sound field are sufficiently distant from the observation location that each incoming signal may be modeled as a planar wavefront arriving from the corresponding source direction. In this case, the sound field is modeled as a superposition of planar wavefronts.

Although such a plane-wave approximation may be less complex than a model of the sound field as a superposition of spherical wavefronts, it lacks information regarding the distance of each source from the observation location, and it may be expected that separability with respect to distance of the various sources in the sound field as modeled and/or synthesized will be poor. A coding approach that models the sound field as a superposition of spherical wavefronts is described.

In a non-limiting example, it is assumed that the inputs to the sound field encoder are the different output channels of a microphone array, such as the Eigenmike® (mh acoustics LLC, San Francisco, Calif.). In one such example, the em32 array includes 32 microphones arranged on the surface of a sphere of diameter 8.4 centimeters, such that each of the output signals pᵢ(t), i=1 to 32, is the pressure recorded at time sample t by microphone i.

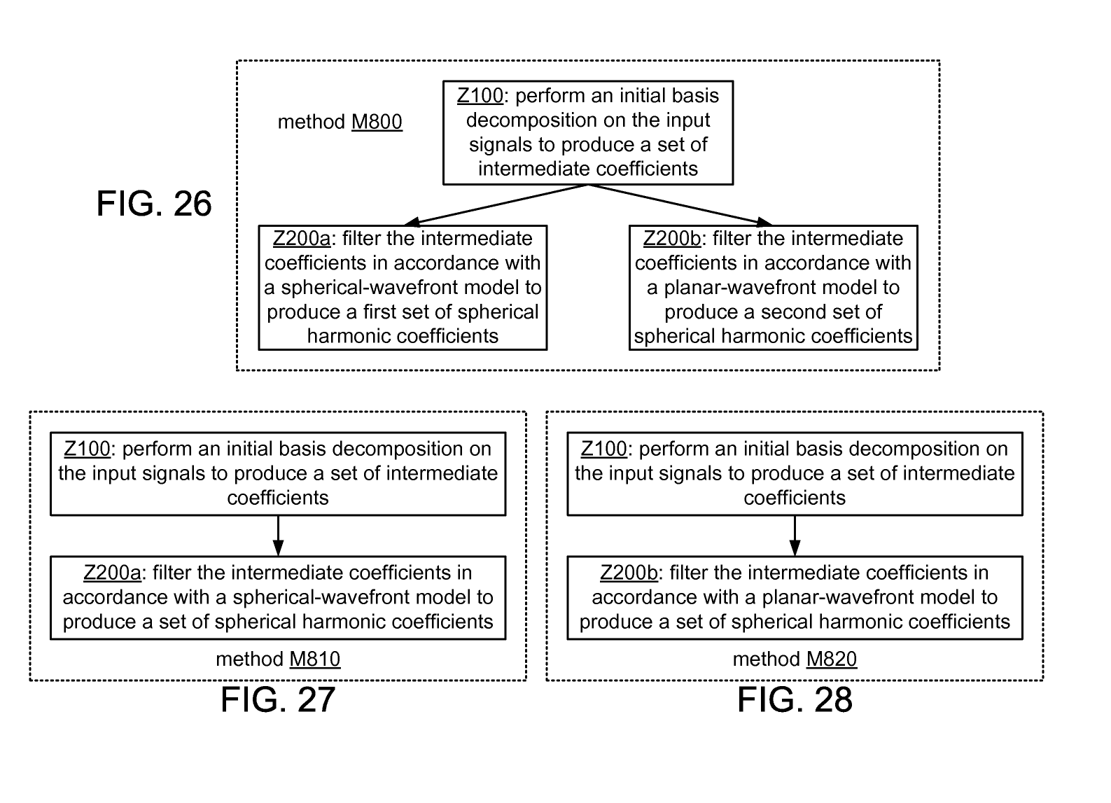

Task Z100, such as that shown in the example of FIG. 26, performs an initial basis decomposition on the input signals to produce a set of intermediate coefficients. In one example, such a decomposition is expressed in the time domain as:

Dₙ^{m}(t)= [symbol] pᵢ(t),Yₙ^{m}(θᵢ,φᵢ) [symbol] , (A1)

where Dₙ^{m} denotes the intermediate coefficient for time sample t, order n, and suborder (e.g., mode) m; and Yₙ^{m} (θᵢ, φᵢ) denotes the spherical basis function, at order n and suborder m, for the elevation θᵢ and azimuth φᵢ associated with microphone i (e.g., the elevation and azimuth of the normal to the sound-sensing surface of microphone i). In a particular but non-limiting example, the maximum N of order n is equal to four, such that a set of twenty-five intermediate coefficients D is obtained for each time sample t. It is expressly noted that task Z100 may also be performed in a frequency domain.

Depending on whether a spherical-wavefront model or a planar-wavefront model is to be used, task Z200a or Z200b (each of which are shown in the example of FIG. 26) is performed to filter the intermediate coefficients. Task Z200a filters the intermediate coefficients in accordance with a spherical-wavefront model to produce a first set of spherical harmonic coefficients. For example, such an operation may be expressed as:

aₙ^{m}(t)=Dₙ^{m}(t)*q_{s.n}(t), (A2a)

where Dₙ^{m} denotes the intermediate coefficient for time sample t, order n, and suborder (e.g., mode) m, aₙ^{m}(t) denotes the time-domain spherical harmonic coefficient at order n and suborder m for time sample t, q_{s.n}(t) denotes the time-domain impulse response of a filter for order n for the spherical-wavefront model, and * is the time-domain convolution operator. Each filter q_{s.n}(t), 1≦n≦N, may be implemented as a finite-impulse-response filter. In one example, each filter q_{s.n}(t) is implemented as an inverse Fourier transform of the frequency-domain filter:

$$\frac{1}{{Q}_{s . n} ( ω )} , where {Q}_{s . n} ( ω ) = \frac{- i}{{( kr )}^{2} {h}_{n}^{( 2 ) ′} ( kr )} , \qquad ( A3a )$$

where k is the wavenumber (ω/c), r is the radius of the spherical region of interest (e.g., the radius of the spherical microphone array), and hₙ⁽²⁾′ denotes the derivative (with respect to r) of the spherical Hankel function of the second kind of order n. It is expressly noted that task Z200a may also be performed in a frequency domain (e.g., as a multiplication).

Task Z200b filters the intermediate coefficients in accordance with a planar-wavefront model to produce a second set of spherical harmonic coefficients. For example, such an operation may be expressed as:

bₙ^{m}(t)=Dₙ^{m}(t)*q_{p.n}(t), (A2b)

where Dₙ^{m} denotes the intermediate coefficient for time sample t, order n, and suborder (e.g., mode) m, bₙ^{m}(t) denotes the time-domain spherical harmonic coefficient at order n and suborder m for time sample t and q_{p.n}(t) denotes the time-domain impulse response of a filter for order n for the planar-wavefront model. Each filter q_{p.n}(t), 1≦n≦N, may be implemented as a finite-impulse-response filter. In one example, each filter q_{p.n}(t) is implemented as an inverse Fourier transform of the frequency-domain filter:

$$\frac{1}{{Q}_{p . n} ( ω )} , where {Q}_{p . n} ( ω ) = \frac{( - 1 ) {i}^{n + 1}}{{( kr )}^{2} {h}_{n}^{( 2 ) ′} ( kr )} . \qquad ( A3b )$$

It is expressly noted that task Z200b may also be performed in a frequency domain (e.g., as a multiplication).

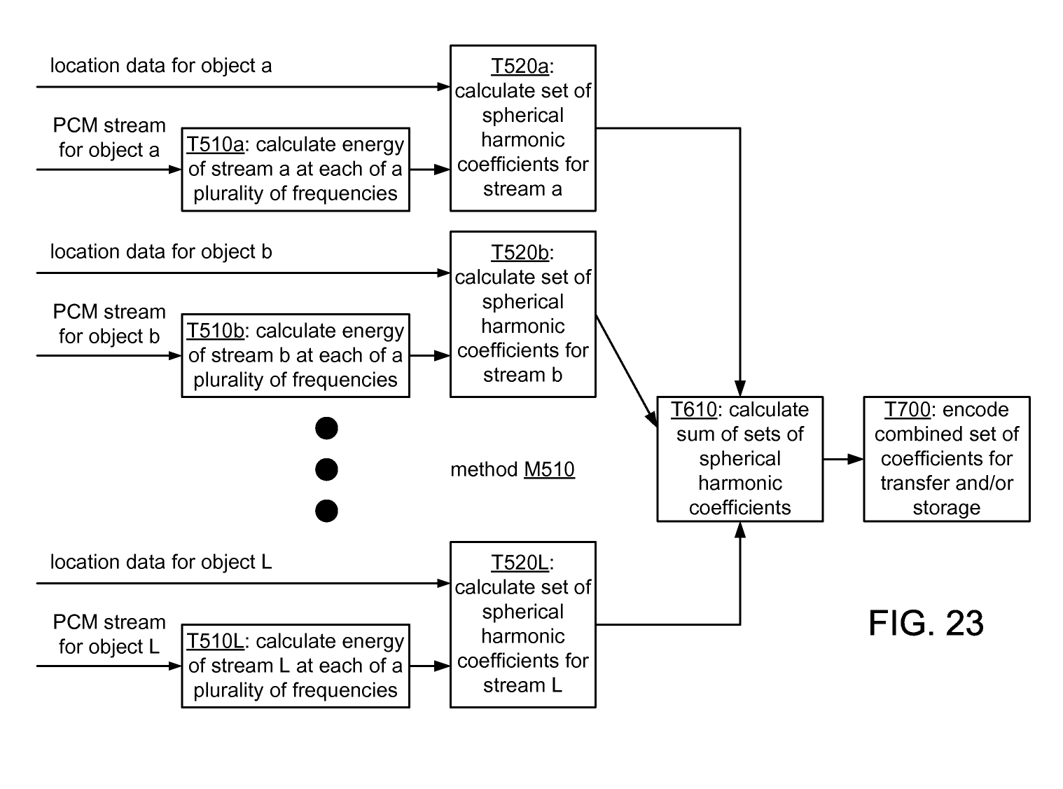

FIG. 23 shows a flowchart for a method M510 that includes L instances T510a-T510L of a task T510 that calculates an energy g(ω) of the object at each of a plurality of frequencies (e.g., by performing a fast Fourier transform on the object's PCM stream). Method M510 also includes L instances T520a-T520L of a task T520 that calculates a set of SHC (e.g., a B-Format signal) for each object based on its energy and location, a task T610 that calculates a sum of the sets of SHC to produce a combined set, and a task T700 that encodes the combined set for transmission and/or storage.

FIG. 23 shows an implementation in which the set of coefficients of the various objects are combined by adding (e.g., coefficient vector addition). In another implementation, the coefficient sets of the objects may be concatenated instead. Encoding of the combined SHC set as shown in FIG. 23 (e.g., task T700) may include one or more lossy or lossless coding techniques, such as quantization (e.g., into one or more codebook indices), error correction coding, redundancy coding, etc., and/or packetization. Additionally or alternatively, such encoding may include encoding into an Ambisonic format, such as B-format, G-format, or Higher-order Ambisonics (HOA).

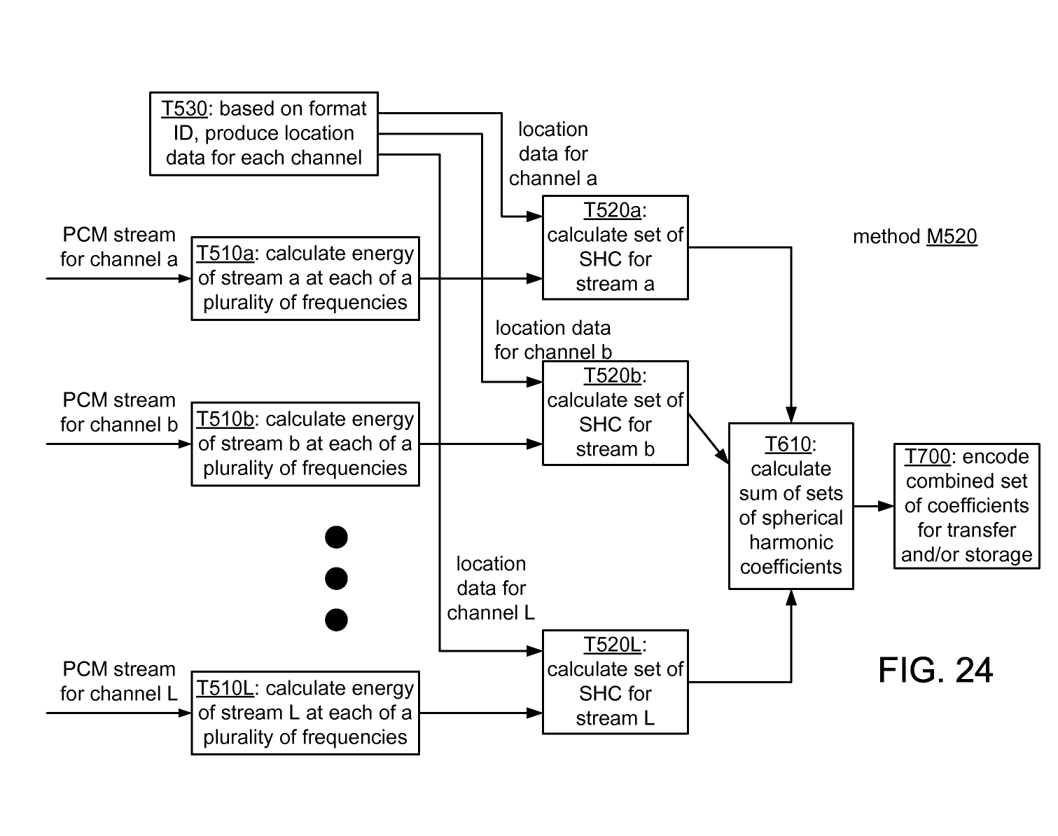

In this context, channel-based signals (or loudspeaker feeds) are just PCM feeds in which the locations of the objects are the pre-determined positions of the loudspeakers. Thus, channel-based audio can be treated as just a subset of object-based audio in which the number of objects is fixed to the number of channels. FIG. 24 shows a flowchart for an implementation M520 of method M510 for encoding a channel-based input. In this case, energy calculation tasks T510a-T510L process PCM streams of the respective channels. Method M520 also includes a task T530 that produces location data for each channel (e.g., the location of a corresponding loudspeaker), based on the format of the channel-based input, to the SHC calculation tasks T520a-T520L. For a case in which only one channel format will be processed (e.g., only 5.1, or only 7.1), task T530 may be configured to produce a corresponding fixed set of location data. For a case in which multiple channel formats will be accommodated, task T530 may be implemented to produce the location data for each channel according to a format identifier (e.g., indicating 5.1, 7.1, or 22.2 format). The format identifier may be received as metadata, for example, or as an indication of the number of input PCM streams that are currently active.

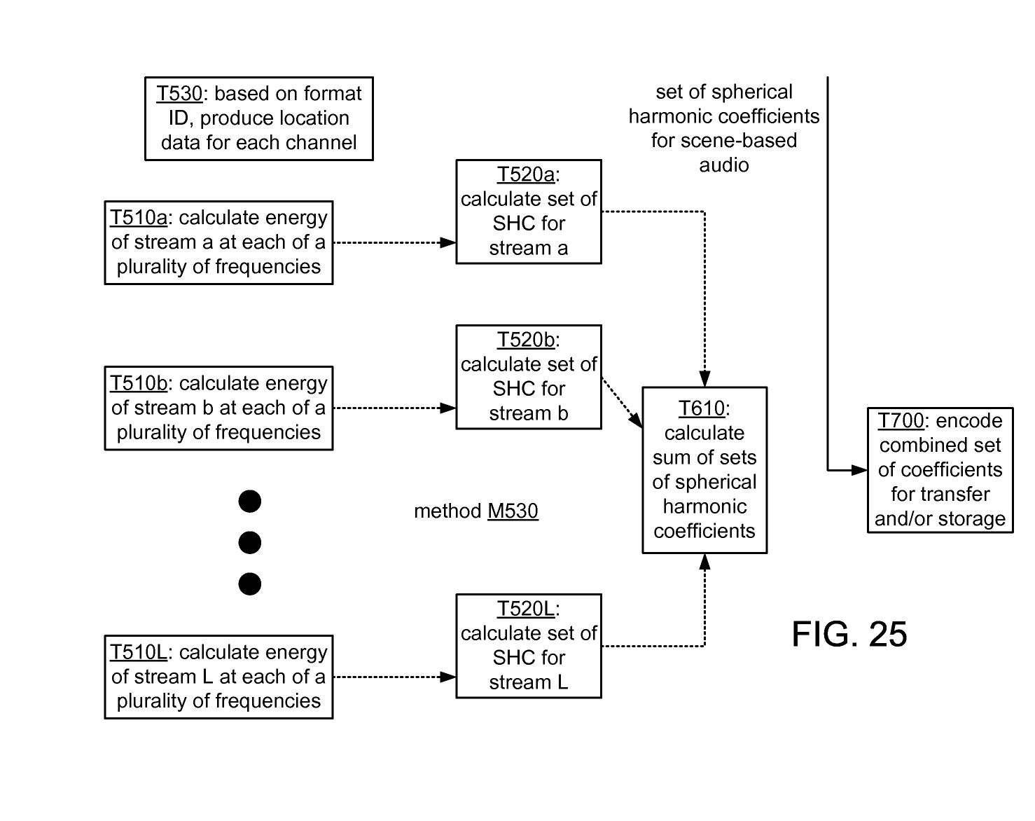

As a scene-based input may already be encoded in SHC form, it may be sufficient for the encoder to process the input (e.g., by quantization, error correction coding, redundancy coding, etc., and/or packetization) into a common format for transfer and/or storage. FIG. 25 shows a flowchart of an implementation M530 of method M520 in which encoding task T500 performs such processing of a scene-based input.

FIG. 26 shows a flowchart of a method M800 according to a general configuration that includes tasks Z100, Z200a, and Z200b. Such a method may also include logic (e.g., responsive to a user interface or other indication) that is configured to initiate one or the other of tasks Z200a and Z200b. Additionally, it is noted that an implementation of tasks Z100 and Z200a without task Z200b (e.g., method M810 as shown in FIG. 27), and an implementation of task Z100 and Z200b without task Z200a (e.g., method M820 as shown in FIG. 28), are also possible.

The spherical harmonic coefficients aₙ^{m}(t) or bₙ^{m}(t), which represent the sound field, may be channel-encoded for transmission and/or storage. For example, such channel encoding may include bandwidth compression. It is also possible to configure such channel encoding to exploit the enhanced separability of the various sources that is provided by the spherical-wavefront model. It may be desirable for a bitstream or file that carries the spherical harmonic coefficients to also include a flag or other indicator whose state indicates whether the spherical harmonic coefficients are of a planar-wavefront-model type or a spherical-wavefront model type. In one example, a file (e.g., a WAV format file) that carries the spherical harmonic coefficients as floating-point values (e.g., 32-bit floating-point values) also includes a metadata portion (e.g., a header) that includes such an indicator and may include other indicators (e.g., a near-field compensation (NFC) flag) and/or text values as well.

At a rendering end, a complementary channel-decoding operation may be performed to recover the spherical harmonic coefficients aₙ^{m}(t) or bₙ^{m}(t). Task Z300a performs a rendering operation to obtain the loudspeaker feeds for the particular loudspeaker array configuration from spherical-wavefront-based SHC (e.g., aₙ^{m}(t) as produced by task Z200a). Task Z300a may be implemented to determine a matrix that can convert between the set of SHC and a set of L audio signals corresponding to the loudspeaker feeds for the particular array of L loudspeakers to be used to synthesize the sound field.

One possible method to determine this matrix is an operation known as “mode-matching.” Here, the loudspeaker feeds are computed by assuming that each loudspeaker produces a spherical wave. In such a scenario, the pressure (as a function of frequency) at a certain position r, θ, φ, due to the l-th loudspeaker, is given by

$${P}_{l} ( ω , r , θ , ϕ ) = {ℊ}_{l} ( ω ) {\sum }_{n = 0}^{∞} {j}_{n} ( kr ) {\sum }_{m = - n}^{n} ( - 4 π i k ) {h}_{n}^{( 2 )} ( {kr}_{l} ) {Y}_{n}^{{m}^{*}} ( {θ}_{l} , {ϕ}_{l} ) {Y}_{n}^{m} ( θ , ϕ ) ,$$

where {r₁, θₗ, φₗ} represents the position of the f-th loudspeaker and g₁(ω) is the loudspeaker feed of the f-th speaker (in the frequency domain). The total pressure Pₜ due to all L speakers is thus given by

$${P}_{t} ( ω , r , θ , ϕ ) = {\sum }_{l = 1}^{L} {ℊ}_{l} ( ω ) {\sum }_{n = 0}^{∞} {j}_{n} ( kr ) {\sum }_{m = - n}^{n} ( - 4 π i k ) {h}_{n}^{( 2 )} ( {kr}_{l} ) {Y}_{n}^{{m}^{*}} ( {θ}_{l} , {ϕ}_{l} ) {Y}_{n}^{m} ( θ , ϕ ) .$$

We also know that the total pressure in terms of the SHC is given by the equation

$${P}_{t} ( ω , r , θ , ϕ ) = 4 π {\sum }_{n = 0}^{∞} {j}_{n} ( kr ) {\sum }_{m = - n}^{n} {A}_{n}^{m} ( k ) {Y}_{n}^{m} ( θ , ϕ )$$

In one example, the time-domain coefficients aₙ^{m}(t) are transformed into frequency-domain coefficients Aₙ^{m}(ω), and task Z300a renders the modeled sound field by solving an expression such as the following to obtain the loudspeaker feeds g₁(ω):

$$( A 4 a ) \\ [ \begin{matrix}{A}_{0}^{0} ( ω ) \\ {A}_{1}^{1} ( ω ) \\ {A}_{1}^{- 1} ( ω ) \\ {A}_{2}^{2} ( ω ) \\ {A}_{2}^{- 2} ( ω )\end{matrix} ] = - ik [ \begin{matrix}{h}_{0}^{( 2 )} ( {kr}_{1} ) {Y}_{0}^{{0}^{*}} ( {θ}_{1} , {ϕ}_{1} ) & {h}_{0}^{( 2 )} ( {kr}_{2} ) {Y}_{0}^{{0}^{*}} ( {θ}_{2} , {ϕ}_{2} ) \cdot & … & … & … \\ {h}_{1}^{( 2 )} ( {kr}_{1} ) {Y}_{1}^{{1}^{*}} ( {θ}_{1} , {ϕ}_{1} ) \cdot & … & … & … & … \\ ⋮ & ⋮ & … & … & … \\ ⋮ & ⋮ & … & … & … \\ ⋮ & ⋮ & … & … & …\end{matrix} ] [ \begin{matrix}{ℊ}_{1} ( ω ) \\ {ℊ}_{2} ( ω ) \\ {ℊ}_{3} ( ω ) \\ {ℊ}_{4} ( ω ) \\ {ℊ}_{5} ( ω )\end{matrix} ] .$$

For convenience, this example shows a maximum N of order n equal to two. It is expressly noted that any other maximum order may be used as desired for the particular implementation (e.g., four, as in the example discussed above with reference to expression A1),

Task Z300b performs a rendering operation to obtain the loudspeaker feeds for the particular loudspeaker array configuration from planar-wavefront-based SHC (e.g., bₙ^{m}(t) as produced by task Z200b). In one example, the time-domain coefficients bₙ^{m}(t) are transformed into frequency-domain coefficients Bₙ^{m}(ω), and task Z300b renders the modeled sound field by solving an expression such as the following to obtain the loudspeaker feeds gₗ(ω):

$$( A 4 b ) \\ [ \begin{matrix}{B}_{0}^{0} ( ω ) \\ {B}_{1}^{1} ( ω ) \\ {B}_{1}^{- 1} ( ω ) \\ {B}_{2}^{2} ( ω ) \\ {B}_{2}^{- 2} ( ω )\end{matrix} ] = ( - 1 ) {i}^{n + 1} k [ \begin{matrix}{h}_{0}^{( 2 )} ( {kr}_{1} ) {Y}_{0}^{{0}^{*}} ( {θ}_{1} , {ϕ}_{1} ) & {h}_{0}^{( 2 )} ( {kr}_{2} ) {Y}_{0}^{{0}^{*}} ( {θ}_{2} , {ϕ}_{2} ) \cdot & … & … & … \\ {h}_{1}^{( 2 )} ( {kr}_{1} ) {Y}_{1}^{{1}^{*}} ( {θ}_{1} , {ϕ}_{1} ) \cdot & … & … & … & … \\ ⋮ & ⋮ & … & … & … \\ ⋮ & ⋮ & … & … & … \\ ⋮ & ⋮ & … & … & …\end{matrix} ] [ \begin{matrix}{ℊ}_{1} ( ω ) \\ {ℊ}_{2} ( ω ) \\ {ℊ}_{3} ( ω ) \\ {ℊ}_{4} ( ω ) \\ {ℊ}_{5} ( ω )\end{matrix} ] .$$

As demonstrated by the conjugates in expression (A4a) and (A4b), the spherical basis functions Yₙ^{m} are complex-valued functions. However, it is also possible to implement tasks Z100, Z300a, and Z300b to use a real-valued set of spherical basis functions instead.

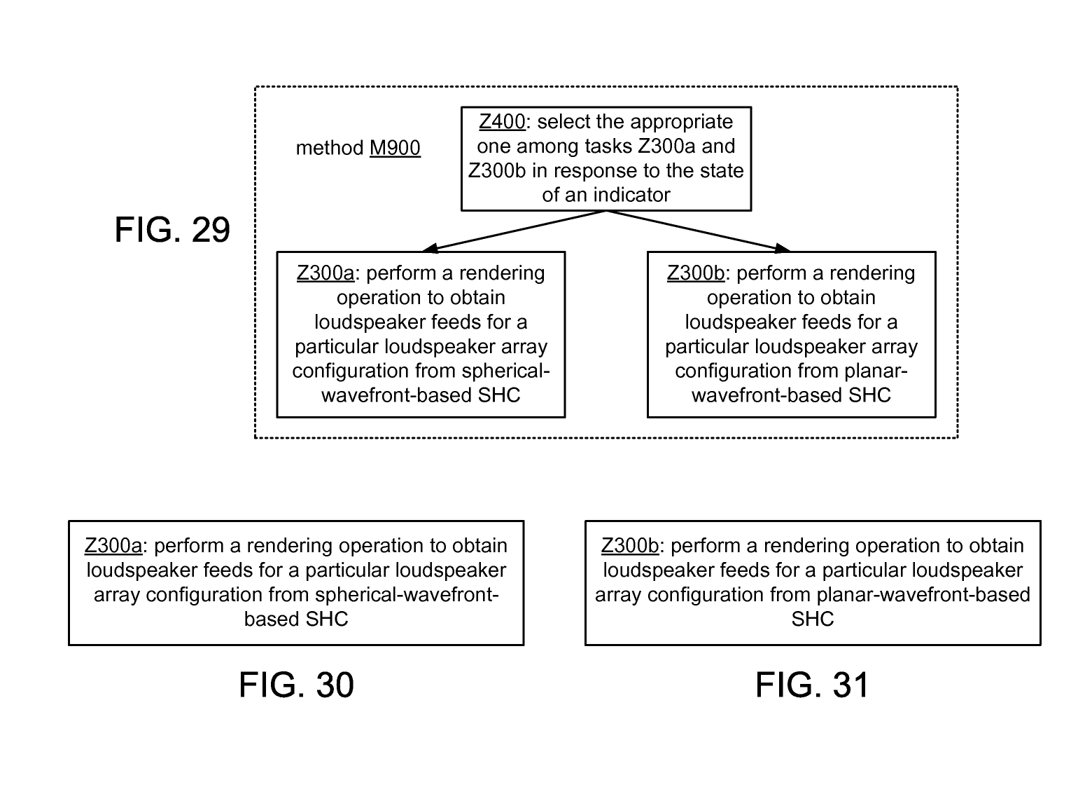

Tasks Z300a and Z300b may be implemented independently, depending upon whether a planar-wavefront-based model or a spherical-wavefront-based model is to be used in the system (e.g., as shown in FIGS. 30 and 31, respectively). Alternatively, both tasks may be implemented together with a selection task Z400 shown in the example of FIG. 29, which selects the appropriate one among tasks Z300a and Z300b in response to the state of an indicator (e.g., a flag as described above) whose state indicates whether the spherical harmonic coefficients are of a planar-wavefront-model type or a spherical-wavefront model type.

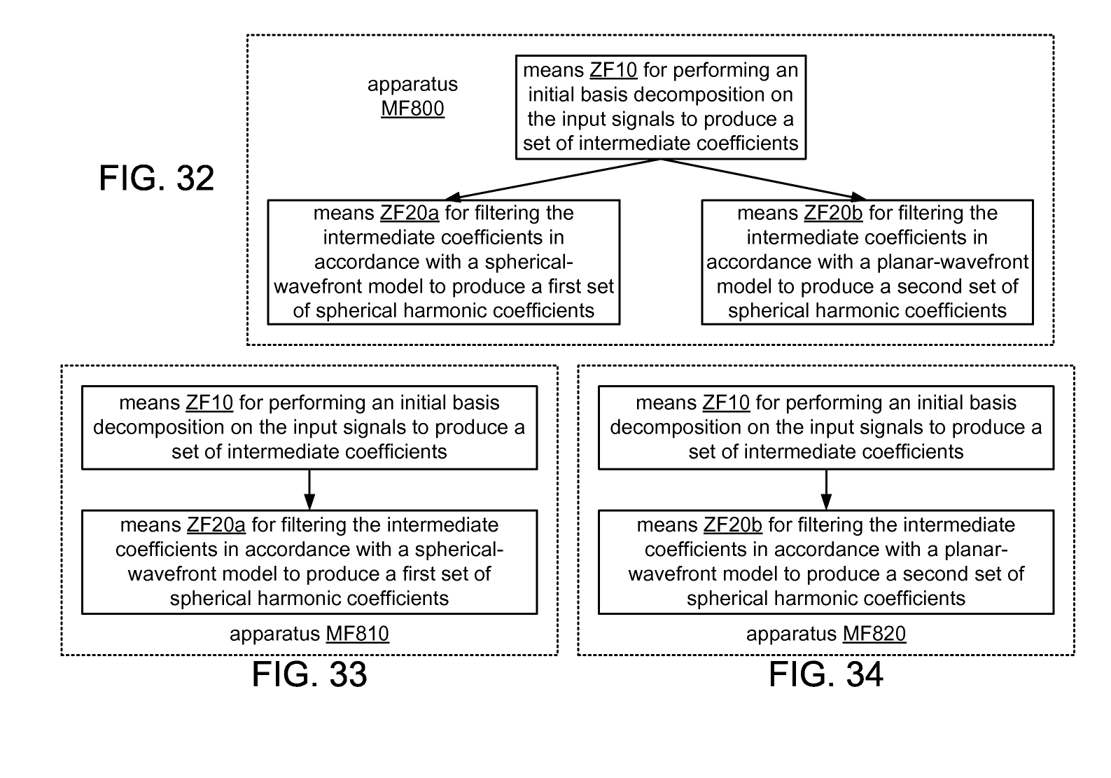

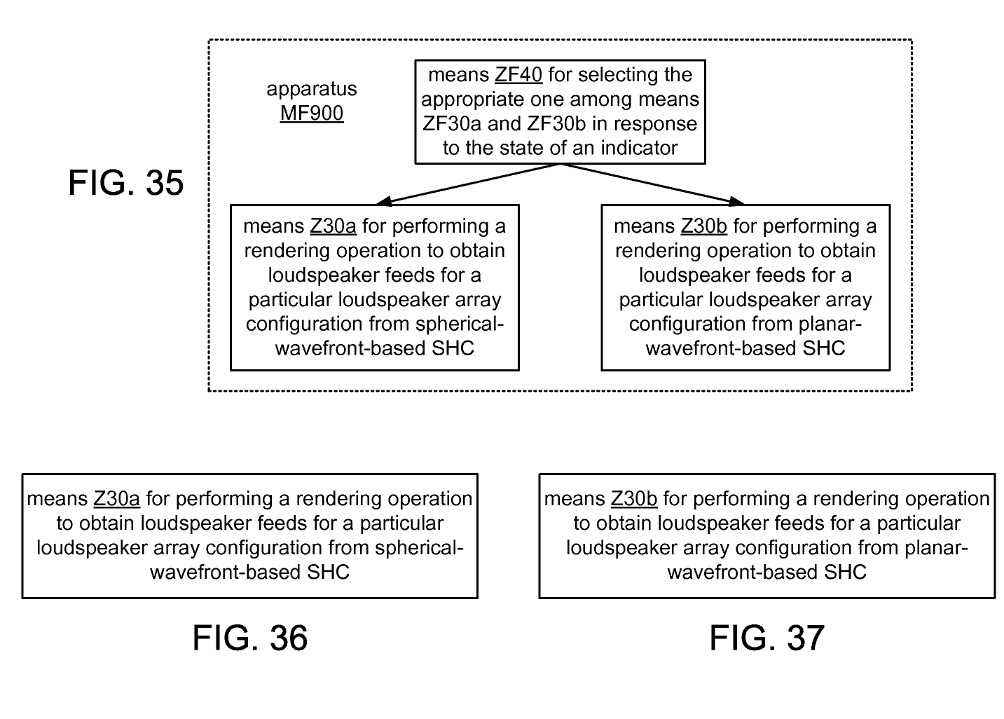

Methods M800, M810, M820, and M900 and tasks Z300a and Z300b shown in the examples of one or more of FIGS. 32-37 may be performed independently. Apparatus including means for performing each task or such methods may also be implemented (e.g., as shown in FIGS. 32 to 37). Encoders configured to perform method M800, M810, and/or M820 may also be implemented. A renderer configured to perform method M900 and renders configured to perform task Z300a or task Z300b may also be implemented.

Task T100 as described herein may be implemented as an instance of method M800, M810, or M820. Analyzer 150 of FIG. 17D and analyzer 150 of FIG. 18 may be implemented to perform method M800, M810, or M820. Task T500 as described herein may be implemented as an instance of method M800, task Z300a, or task Z300b.

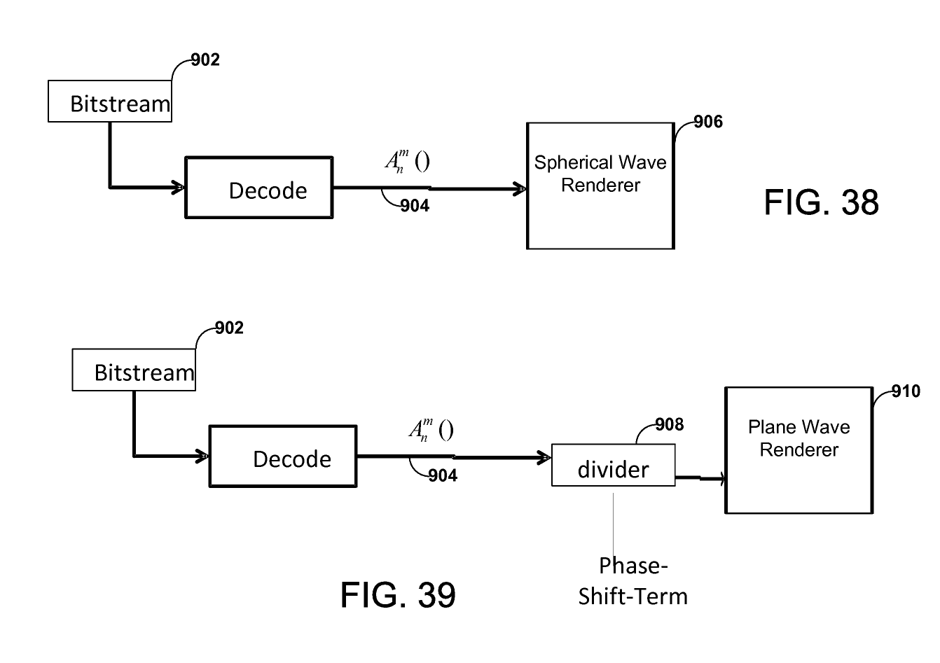

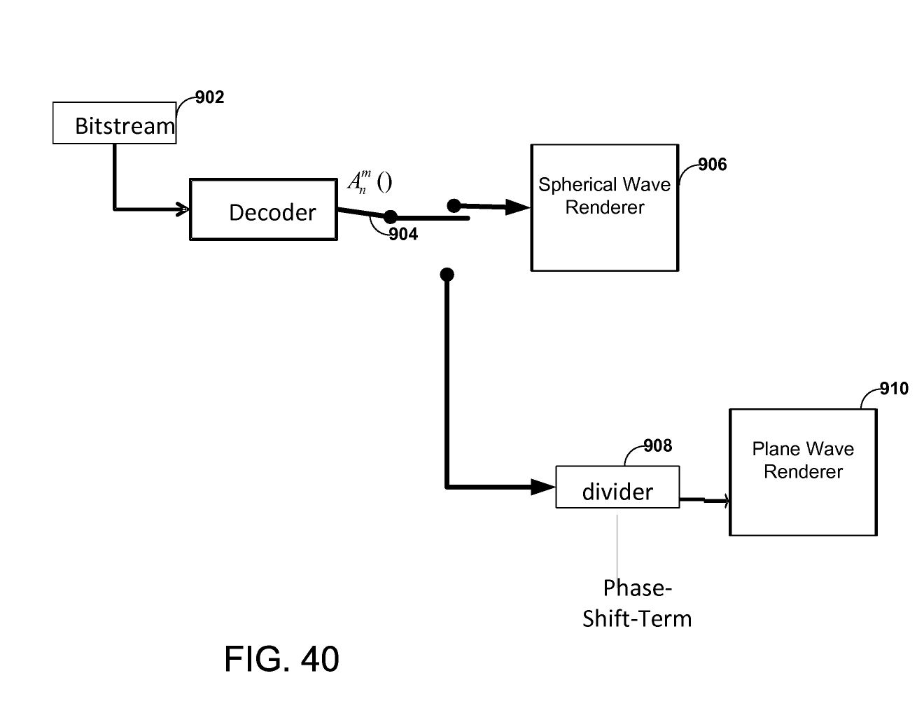

FIGS. 38 and 39 show examples in which a bitstream 902 is decoded to obtain a set of SHC Aₙ^{m} 904 that are based on a spherical-wavefront model as described herein. In FIG. 38, a spherical wave renderer 906 is used to render the set of SHC 904 into the appropriate loudspeaker geometry. In FIG. 39, a divider 908 is used to apply a phase-shift to the set of SHC 904 before it is rendered by a plane wave renderer 910. In one example, the divider 908 is implemented using a Hilbert transformer. FIG. 40 shows an example in which a desired rendering path is selected.

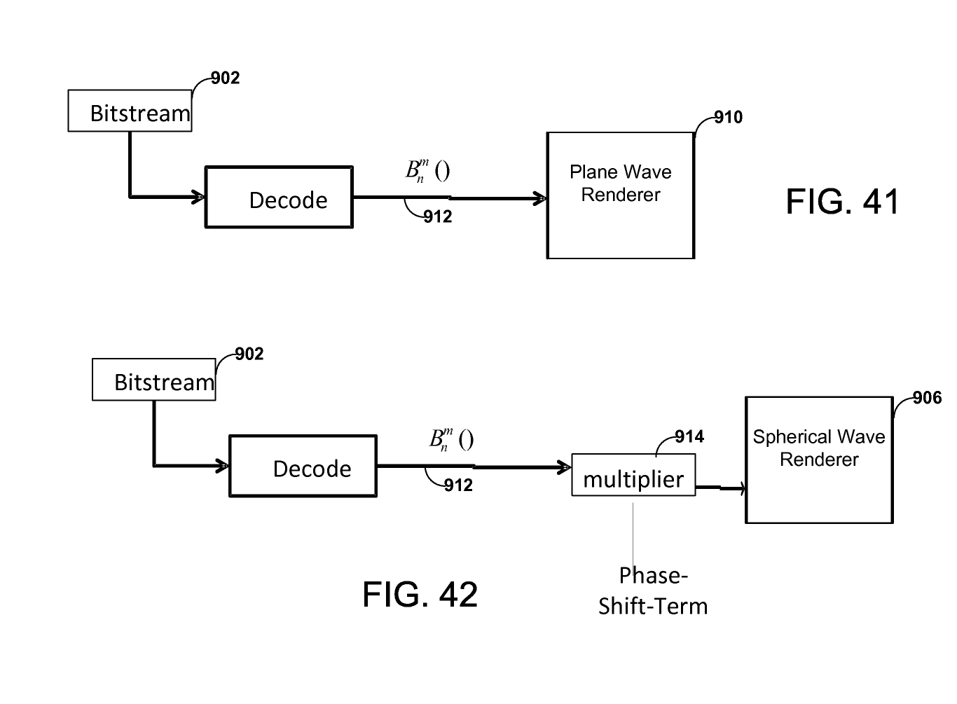

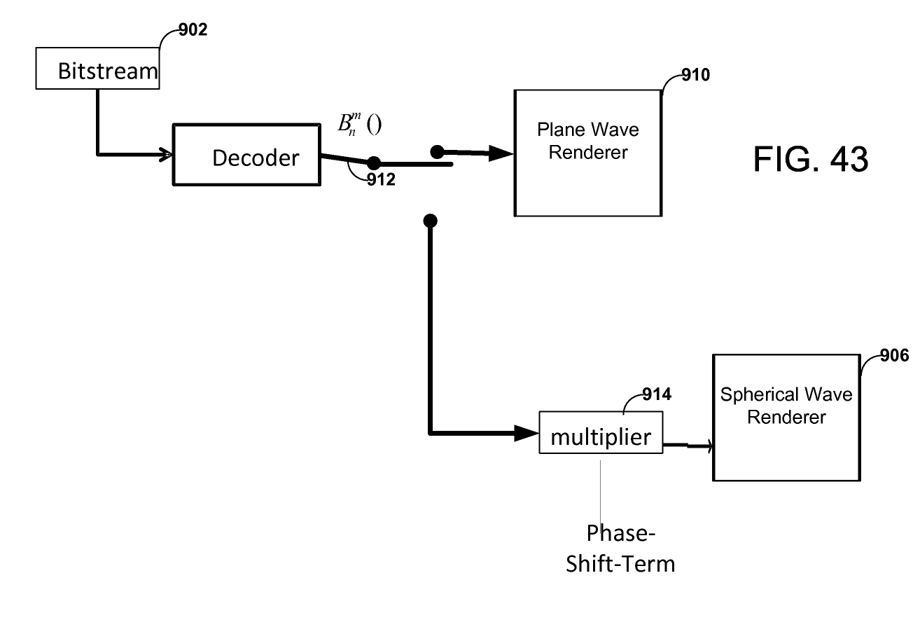

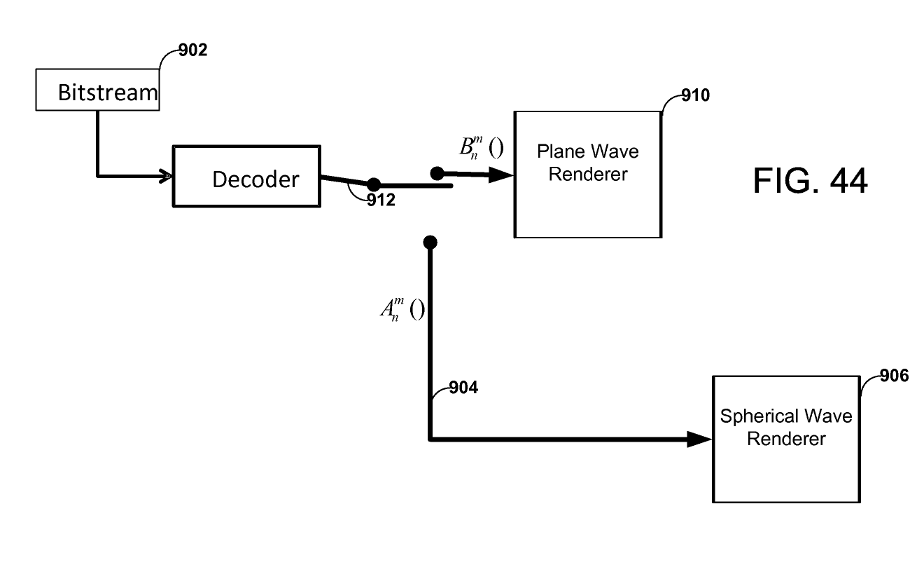

FIGS. 41 and 42 show examples in which a bitstream 902 is decoded to obtain a set of SHC Bₙ^{m} 912 that are based on a planar-wavefront model as described herein. In FIG. 41, a plane wave renderer 910 is used to render the set of SHC 912 into the appropriate loudspeaker geometry. In FIG. 42, a multiplier 914 is used to apply a phase-shift to the set of SHC 912 before it is rendered by a spherical wave renderer 906. In one example, the multiplier 914 is implemented using a Hilbert transformer. FIG. 43 shows an example in which a desired rendering path is selected. FIG. 44 shows an example in which an appropriate renderer is selected according to the type of SHC (e.g., as described above with reference to task Z400).

In this way, various aspects of the techniques may provide for a unified encoder as set forth in accordance with the following examples, each of which is described in more detail above.

### Example 1

An apparatus comprising: a unified encoder for producing a unified encoded signal; and a memory for storing the unified encoded signal.

### Example 2

A unified encoder comprising: a spherical harmonic analysis module for transforming an audio coded signal into a first spherical harmonic (SH) based coded signal; a combiner for combining the first SH based coded signal with a second SH based coded signal; and a unified coefficient set encoder for producing a unified encoded signal.

### Example 3

The unified encoder of Example 2, further comprising: a format detector for determining a format of the audio coded signal and producing a corresponding format indicator. Again, this architecture may be deployed in or otherwise included in any number of systems, such as one or more of a home theater system, a decoding system, a transportation system (e.g., a bus, care, plane, etc. entertainment system), and a broadcasting equipment system.

### Example 4

The unified encoder of any one of Examples 2 and 3, wherein the audio coded signal is a channel-based audio coded signal.

### Example 5

The unified encoder of any one of Examples 2 and 3, wherein the audio coded signal is an object-based audio coded signal.

### Example 6

The unified encoder of any one of Examples 2-5, further comprising a second spherical harmonic analysis module for transforming a second audio coded signal into the second spherical harmonic (SH) based coded signal.

### Example 7

A method of audio signal processing, said method comprising: combining a first hierarchical set of elements that describes a first sound field and a second hierarchical set of elements that describes a second sound field to produce a combined hierarchical set of elements that describes a combined sound field.

### Example 8

The method according to Example 7, wherein said combining comprises summing corresponding elements of the first and second hierarchical sets to produce the combined hierarchical set.

### Example 9

A method of audio signal processing, said method comprising:

for each of a plurality of audio signals, encoding the signal and spatial information for the signal into a corresponding hierarchical set of elements that describe a sound field; and combining the plurality of hierarchical sets to produce a combined hierarchical set of elements that describes a combined sound field.

### Example 10

The method according to Example 9, wherein each of the plurality of audio signals is a frame of a corresponding audio stream.

### Example 11

The method according to Example 9, wherein each of the plurality of audio signals is a frame of a pulse-code-modulation (PCM) stream.

### Example 12

The method according to any one of Examples 9-11, wherein, for each of the plurality of audio signals, said spatial information indicates a location in space for the corresponding audio signal.

### Example 13

The method according to any one of Examples 9-11, wherein, for each of the plurality of audio signals, said spatial information indicates a location in space of a source of the corresponding audio signal.

### Example 14

The method according to any one of Examples 9-13, wherein, for at least one among the plurality of audio signals, said spatial information indicates a diffusivity of the audio signal.

### Example 15

The method according to any one of Examples 9-14, wherein each of the plurality of audio signals is an audio object.

### Example 16

The method according to any one of Examples 9-14, wherein each of the plurality of audio signals is a loudspeaker channel.

### Example 17

The method according to any one of Examples 9-16, wherein said elements are coefficients of a corresponding set of basis functions.

### Example 18

The method according to any one of Examples 9-16, wherein said elements are coefficients of a corresponding set of spherical harmonic basis functions.

### Example 19

The method according to any one of Examples 17 and 18, wherein said set of basis functions describes a space with higher resolution along a first axis than along a second axis that is orthogonal to the first axis.

### Example 20

The method according to any one of Examples 9-19, wherein at least one of said corresponding hierarchical sets of elements describes a space with higher resolution along a first axis than along a second axis that is orthogonal to the first axis.

### Example 21

The method according to any one of Examples 9-20, wherein each of said corresponding hierarchical sets describes the corresponding sound field in at least two spatial dimensions.

### Example 22

The method according to any one of Examples 9-20, wherein each of said corresponding hierarchical sets describes the corresponding sound field in three spatial dimensions.

### Example 23

The method according to any one of Examples 9-22, wherein a first of the plurality of hierarchical sets has more elements than a second of the plurality of hierarchical sets.

### Example 24

The method according to Example 23, wherein the number of elements in the combined hierarchical set is at least equal to the number of elements in the second of the plurality of hierarchical sets.

### Example 25

The method according to any one of claims 9-24, wherein said combining comprises summing corresponding elements of the plurality of hierarchical sets to produce the combined hierarchical set.

### Example 26

The method according to any one of claims 9-24, wherein said combining comprises concatenating the plurality of hierarchical sets to produce a vector for a frame of a combined audio signal.

### Example 27

A non-transitory computer-readable data storage medium having tangible features that cause a machine reading the features to perform a method according to any one of claims 9-26.

### Example 28

An apparatus for audio signal processing, said apparatus comprising: means for encoding each of a plurality of audio signals, with spatial information for the signal, into a corresponding hierarchical set of elements that describe a sound field; and means for combining the plurality of hierarchical sets to produce a combined hierarchical set of elements that describes a combined sound field.

### Example 29

An apparatus for audio signal processing, said apparatus comprising: an encoder configured to encode each of a plurality of audio signals, with spatial information for the signal, into a corresponding hierarchical set of elements that describe a sound field; and a combiner configured to combine the plurality of hierarchical sets to produce a combined hierarchical set of elements that describes a combined sound field.

### Example 30

An apparatus for audio signal processing, said apparatus comprising: means for encoding a frame of each of a plurality of audio signals, with spatial information for the frame, into a corresponding hierarchical set of elements that describe a sound field; and means for concatenating the plurality of hierarchical sets to produce a vector for a frame of a combined audio signal.

### Example 31

An apparatus for audio signal processing, said apparatus comprising: an encoder configured to encode a frame of each of a plurality of audio signals, with spatial information for the frame, into a corresponding hierarchical set of elements that describe a sound field; and a concatenator configured to concatenate the plurality of hierarchical sets to produce a vector for a frame of a combined audio signal.

### Example 32

A method of audio signal processing, said method comprising: performing an initial basis decomposition on a plurality of input signals to produce a set of intermediate coefficients; and filtering the intermediate coefficients in accordance with a spherical-wavefront model to produce a set of spherical harmonic coefficients.

### Example 33

A method of audio signal processing, said method comprising: performing an initial basis decomposition on a plurality of input signals to produce a set of intermediate coefficients; filtering the intermediate coefficients in accordance with one among (A) a spherical-wavefront model and (B) a planar-wavefront model to produce a set of spherical harmonic coefficients; and producing a file that includes the set of spherical harmonic coefficients and an indicator whose state indicates the one among the spherical-wavefront model and the planar-wavefront model.

### Example 34

A method of audio signal processing, said method comprising: performing a selected one among (A) a first rendering operation to obtain loudspeaker feeds for a particular loudspeaker array configuration from a set of spherical-wavefront-based spherical harmonic coefficients and (B) a second rendering operation to obtain loudspeaker feeds for the particular loudspeaker array configuration from a set of planar-wavefront-based spherical harmonic coefficients; and selecting said selected operation in response to the state of an indicator associated with the spherical harmonic coefficients.

### Example 35

A method of audio signal processing, said method comprising: receiving a plurality of bandwidth compressed spherical harmonic coefficients, having a mode and order, over a transmission channel; and decoding the received bandwidth compressed spherical harmonic coefficient to produce a plurality of synthetic spherical harmonic coefficients.

### Example 36

The method of Example 35, further comprising rendering the plurality of synthetic spherical harmonic coefficients with a spherical wave renderer to produce a sound field.

### Example 37

The method of Example 35, further comprising multiplying each synthetic spherical harmonic coefficient in the plurality of coefficients by a phase-shift constant, to produce a plurality of phase-shifted synthetic spherical harmonic coefficients.

### Example 38

The method of Example 37, wherein the plurality of phase shifted synthetic spherical harmonic coefficients are rendered with a spherical wave renderer to produce a sound field.

### Example 39

The method of Example 37, wherein the phase-shift constant used in the multiplication is based on the order of the bandwidth compressed spherical harmonic coefficients.

### Example 40

The method of Example 37, wherein the phase-shift constant is retrieved from a lookup-table.

### Example 41

The method of Example 37, wherein the phase-shift constant is calculated based on the order of the bandwidth compressed spherical harmonic coefficients.

### Example 42

The method of Example 35, further comprising dividing each synthetic spherical harmonic coefficient in the plurality of coefficients by a phase-shift constant, to produce a plurality of phase-shifted synthetic spherical harmonic coefficients.

### Example 43

The method of Example 42, wherein the plurality of phase shifted synthetic spherical harmonic coefficients are rendered with a plane wave renderer to produce a sound field.

### Example 44

A method comprising: transmitting a plurality of spherical harmonic coefficients without dividing by a phase-shift term based on the order of the spherical harmonic coefficients.

### Example 45

A method comprising: filtering a series of spherical harmonic coefficients with a plurality of filters, where each filter is based on the order of the spherical harmonic coefficients.

### Example 46

The method of Example 45, wherein each filter in the plurality of filters has an input different modes of the spherical harmonic coefficients.

### Example 47

A device comprising: a decoder configured to decode a plurality of bandwidth compressed spherical harmonic coefficients, having a mode and order, configured to produce a plurality of synthetic spherical harmonic coefficients.

### Example 48

The device of Example 47, further comprising a spherical wave renderer, coupled to the decoder, configured to produce a sound field.

### Example 49

The device of Example 47, further comprising a plane wave renderer, coupled to the decoder, configured to produce a sound field.

### Example 50

The device of Example 47, further comprising a divider, coupled to the decoder, configured to divide the output of the decoder by a phase-shift constant term.

### Example 51

The device of Example 50, further comprising a plane wave renderer configured to produce a sound field from the resulting output of the divider.

### Example 52

The device of Example 50, wherein the phase-shift constant term is based on the order of the plurality of the synthetic spherical harmonic coefficients.

### Example 53

The device of Example 50, wherein the phase-shift constant term is retrieved from a lookup-table.

### Example 54

The device of Example 50, wherein the phase-shift constant term is calculated based on the order of the plurality of the synthetic spherical harmonic coefficients.

### Example 55

The device of Example 50, further comprising a plane wave renderer configured to produce a sound field from the resulting output of the divider.

### Example 56

The device of Example 47, further comprising a multiplier, coupled to the decoder, configured to multiply the output of the decoder by a phase-shift constant term.

### Example 57

The device of Example 56, wherein the phase-shift constant term is based on the order of the plurality of the synthetic spherical harmonic coefficients.

### Example 58

The device of Example 56, wherein the phase-shift constant term is retrieved from a lookup-table.

### Example 59

The device of Example 56, wherein the phase-shift constant term is calculated based on the order of the plurality of the synthetic spherical harmonic coefficients.

### Example 60

A device comprising: a first filter configured to filter a first intermediate form of spherical harmonic coefficients; and a second filter configured to filter a second intermediate form of spherical harmonic coefficients.

### Example 61

The device of Example 60, wherein the first filter is configured to phase-shift the intermediate form of spherical harmonic coefficients, to produce a first plurality of spherical harmonic coefficients.

### Example 62

The device of Example 61, wherein the phase-shift is pi/2.

### Example 63

The device of Example 60, wherein the second filter is configured to phase-shift the intermediate form of spherical harmonic coefficients, to produce a second plurality of spherical harmonic coefficients.

### Example 64

The device of Example 63, wherein the phase-shift is pi/2.

### Example 1A

An apparatus comprising: a unified encoder for producing a unified encoded signal; and a memory for storing the unified encoded signal.

### Example 2A

The apparatus of Example 1A, wherein the unified encoder comprises: a spherical harmonic analysis module for transforming an audio coded signal into a first spherical harmonic (SH) based coded signal; a combiner for combining the first SH based coded signal with a second SH based coded signal; and a unified coefficient set encoder for producing the unified encoded signal.

### Example 3A

The apparatus of Example 2A, wherein the unified encoder further comprises: a format detector for determining a format of the audio coded signal and producing a corresponding format indicator.

### Example 4A

The apparatus of any one of Examples 2A and 3A, wherein the audio coded signal is a channel-based audio coded signal.

### Example 5A

The apparatus of any one of Examples 2A and 3A, wherein the audio coded signal is an object-based audio coded signal.

### Example 6A

The apparatus of any one of Examples 2A-5A, wherein the unified encoder further comprises a second spherical harmonic analysis module for transforming a second audio coded signal into the second spherical harmonic (SH) based coded signal.

### Example 7A

A method comprising: producing, with a unified encoder, a unified encoded signal; and storing the unified encoded signal to a memory.

### Example 8A

The method of Example 7A, wherein producing the unified encoded signal comprises: transforming an audio coded signal into a first spherical harmonic (SH) based coded signal; combining the first SH based coded signal with a second SH based coded signal to obtain a combined SH based coded signal; and producing the unified encoded signal based on the combined SH based coded signal.

### Example 9A

The method of Example 8A, wherein producing the unified encoded signal comprises: determining a format of the audio coded signal and producing a corresponding format indicator.

### Example 10A

The method of any one of Examples 8A and 9A, wherein the audio coded signal is a channel-based audio coded signal.

### Example 11A

The method of any one of Examples 8A and 9A, wherein the audio coded signal is an object-based audio coded signal.

### Example 12A

The method of any one of Examples 8A-11A, wherein producing the unified encoded signal comprises transforming a second audio coded signal into the second spherical harmonic (SH) based coded signal.

### Example 13A

A non-transitory computer readable storage medium having stored thereon instructions that when executed cause one or more processors to perform the method recited by any combination of Examples 7A-12A.

### Example 14A

An apparatus comprising means for performing each of the steps of the method recited by any combination of Examples 7A-12A.

### Example 15A

A method of audio signal processing, said method comprising: receiving a plurality of bandwidth compressed spherical harmonic coefficients, having a mode and order, over a transmission channel; and decoding the received bandwidth compressed spherical harmonic coefficient to produce a plurality of synthetic spherical harmonic coefficients.

### Example 16A

The method of Example 15A, further comprising rendering the plurality of synthetic spherical harmonic coefficients with a spherical wave renderer to produce a sound field.

### Example 17A

The method of Example 15A, further comprising multiplying each synthetic spherical harmonic coefficient in the plurality of coefficients by a phase-shift constant, to produce a plurality of phase-shifted synthetic spherical harmonic coefficients.

### Example 18A

The method of Example 17A, wherein the plurality of phase shifted synthetic spherical harmonic coefficients are rendered with a spherical wave renderer to produce a sound field.

### Example 19A

The method of Example 17A, wherein the phase-shift constant used in the multiplication is based on the order of the bandwidth compressed spherical harmonic coefficients.

### Example 20A

The method of Example 17A, wherein the phase-shift constant is retrieved from a lookup-table.

### Example 21A

The method of Example 17A, wherein the phase-shift constant is calculated based on the order of the bandwidth compressed spherical harmonic coefficients.

### Example 22A

The method of Example 15A, further comprising dividing each synthetic spherical harmonic coefficient in the plurality of coefficients by a phase-shift constant, to produce a plurality of phase-shifted synthetic spherical harmonic coefficients.

### Example 23A

The method of Example 22A, wherein the plurality of phase shifted synthetic spherical harmonic coefficients are rendered with a plane wave renderer to produce a sound field.

### Example 24A

A non-transitory computer readable storage medium having stored thereon instructions that when executed cause one or more processors to perform the method recited by any combination of Examples 15A-23A.

### Example 25A

An apparatus comprising means for performing each of the steps of the method recited by any combination of Examples 15A-23A.

The methods and apparatus disclosed herein may be applied generally in any transceiving and/or audio sensing application, including mobile or otherwise portable instances of such applications and/or sensing of signal components from far-field sources. For example, the range of configurations disclosed herein includes communications devices that reside in a wireless telephony communication system configured to employ a code-division multiple-access (CDMA) over-the-air interface. Nevertheless, it would be understood by those skilled in the art that a method and apparatus having features as described herein may reside in any of the various communication systems employing a wide range of technologies known to those of skill in the art, such as systems employing Voice over IP (VoIP) over wired and/or wireless (e.g., CDMA, TDMA, FDMA, LTE, GSM, UMTS, and/or TD-SCDMA) transmission channels.

It is expressly contemplated and hereby disclosed that communications devices disclosed herein (e.g., smartphones, tablet computers) may be adapted for use in networks that are packet-switched (for example, wired and/or wireless networks arranged to carry audio transmissions according to protocols such as VoIP) and/or circuit-switched. It is also expressly contemplated and hereby disclosed that communications devices disclosed herein may be adapted for use in narrowband coding systems (e.g., systems that encode an audio frequency range of about four or five kilohertz) and/or for use in wideband coding systems (e.g., systems that encode audio frequencies greater than five kilohertz), including whole-band wideband coding systems and split-band wideband coding systems.

The foregoing presentation of the described configurations is provided to enable any person skilled in the art to make or use the methods and other structures disclosed herein. The flowcharts, block diagrams, and other structures shown and described herein are examples only, and other variants of these structures are also within the scope of the disclosure. Various modifications to these configurations are possible, and the generic principles presented herein may be applied to other configurations as well. Thus, the present disclosure is not intended to be limited to the configurations shown above but rather is to be accorded the widest scope consistent with the principles and novel features disclosed in any fashion herein, including in the attached claims as filed, which form a part of the original disclosure.

Those of skill in the art will understand that information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

Important design requirements for implementation of a configuration as disclosed herein may include minimizing processing delay and/or computational complexity (typically measured in millions of instructions per second or MIPS), especially for computation-intensive applications, such as playback of compressed audio or audiovisual information (e.g., a file or stream encoded according to a compression format, such as one of the examples identified herein) or applications for wideband communications (e.g., voice communications at sampling rates higher than eight kilohertz, such as 12, 16, 44.1, 48, or 192 kHz).

Goals of a multi-microphone processing system may include achieving ten to twelve dB in overall noise reduction, preserving voice level and color during movement of a desired speaker, obtaining a perception that the noise has been moved into the background instead of an aggressive noise removal, dereverberation of speech, and/or enabling the option of post-processing for more aggressive noise reduction.

An apparatus as disclosed herein (e.g., any of apparatus A100, A110, A120, A200, A300, A400, MF100, MF110, MF120, MF200, MF300, MF400, UE10, UD10, UE100, UE250, UE260, UE300, UE310, UE350, UE360, MF800, MF810, MF820 and MF900) may be implemented in any combination of hardware with software, and/or with firmware, that is deemed suitable for the intended application. For example, the elements of such an apparatus may be fabricated as electronic and/or optical devices residing, for example, on the same chip or among two or more chips in a chipset. One example of such a device is a fixed or programmable array of logic elements, such as transistors or logic gates, and any of these elements may be implemented as one or more such arrays. Any two or more, or even all, of the elements of the apparatus may be implemented within the same array or arrays. Such an array or arrays may be implemented within one or more chips (for example, within a chipset including two or more chips).

One or more elements of the various implementations of the apparatus disclosed herein (e.g., any of apparatus A100, A110, A120, A200, A300, A400, MF100, MF110, MF120, MF200, MF300, MF400, UE10, UD10, UE100, UE250, UE260, UE300, UE310, UE350, UE360, MF800, MF810, MF820 and MF900) may also be implemented in whole or in part as one or more sets of instructions arranged to execute on one or more fixed or programmable arrays of logic elements, such as microprocessors, embedded processors, IP cores, digital signal processors, FPGAs (field-programmable gate arrays), ASSPs (application-specific standard products), and ASICs (application-specific integrated circuits). Any of the various elements of an implementation of an apparatus as disclosed herein may also be embodied as one or more computers (e.g., machines including one or more arrays programmed to execute one or more sets or sequences of instructions, also called “processors”), and any two or more, or even all, of these elements may be implemented within the same such computer or computers.

A processor or other means for processing as disclosed herein may be fabricated as one or more electronic and/or optical devices residing, for example, on the same chip or among two or more chips in a chipset. One example of such a device is a fixed or programmable array of logic elements, such as transistors or logic gates, and any of these elements may be implemented as one or more such arrays. Such an array or arrays may be implemented within one or more chips (for example, within a chipset including two or more chips). Examples of such arrays include fixed or programmable arrays of logic elements, such as microprocessors, embedded processors, IP cores, DSPs, FPGAs, ASSPs, and ASICs. A processor or other means for processing as disclosed herein may also be embodied as one or more computers (e.g., machines including one or more arrays programmed to execute one or more sets or sequences of instructions) or other processors. It is possible for a processor as described herein to be used to perform tasks or execute other sets of instructions that are not directly related to an audio coding procedure as described herein, such as a task relating to another operation of a device or system in which the processor is embedded (e.g., an audio sensing device). It is also possible for part of a method as disclosed herein to be performed by a processor of the audio sensing device and for another part of the method to be performed under the control of one or more other processors.

Those of skill will appreciate that the various illustrative modules, logical blocks, circuits, and tests and other operations described in connection with the configurations disclosed herein may be implemented as electronic hardware, computer software, or combinations of both. Such modules, logical blocks, circuits, and operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a non-transitory storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It is noted that the various methods disclosed herein (e.g., any of methods M100, M110, M120, M200, M300, M400, M800, M810, M820 and M900) may be performed by an array of logic elements such as a processor, and that the various elements of an apparatus as described herein may be implemented as modules designed to execute on such an array. As used herein, the term “module” or “sub-module” can refer to any method, apparatus, device, unit or computer-readable data storage medium that includes computer instructions (e.g., logical expressions) in software, hardware or firmware form. It is to be understood that multiple modules or systems can be combined into one module or system and one module or system can be separated into multiple modules or systems to perform the same functions. When implemented in software or other computer-executable instructions, the elements of a process are essentially the code segments to perform the related tasks, such as with routines, programs, objects, components, data structures, and the like. The term “software” should be understood to include source code, assembly language code, machine code, binary code, firmware, macrocode, microcode, any one or more sets or sequences of instructions executable by an array of logic elements, and any combination of such examples. The program or code segments can be stored in a processor-readable storage medium or transmitted by a computer data signal embodied in a carrier wave over a transmission medium or communication link.

The implementations of methods, schemes, and techniques disclosed herein may also be tangibly embodied (for example, in one or more computer-readable media as listed herein) as one or more sets of instructions readable and/or executable by a machine including an array of logic elements (e.g., a processor, microprocessor, microcontroller, or other finite state machine). The term “computer-readable medium” may include any medium that can store or transfer information, including volatile, nonvolatile, removable and non-removable media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk, a fiber optic medium, a radio frequency (RF) link, or any other medium which can be used to store the desired information and which can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such embodiments.

Each of the tasks of the methods described herein may be embodied directly in hardware, in a software module executed by a processor, or in a combination of the two. In a typical application of an implementation of a method as disclosed herein, an array of logic elements (e.g., logic gates) is configured to perform one, more than one, or even all of the various tasks of the method. One or more (possibly all) of the tasks may also be implemented as code (e.g., one or more sets of instructions), embodied in a computer program product (e.g., one or more data storage media such as disks, flash or other nonvolatile memory cards, semiconductor memory chips, etc.), that is readable and/or executable by a machine (e.g., a computer) including an array of logic elements (e.g., a processor, microprocessor, microcontroller, or other finite state machine). The tasks of an implementation of a method as disclosed herein may also be performed by more than one such array or machine. In these or other implementations, the tasks may be performed within a device for wireless communications such as a cellular telephone or other device having such communications capability. Such a device may be configured to communicate with circuit-switched and/or packet-switched networks (e.g., using one or more protocols such as VoIP). For example, such a device may include RF circuitry configured to receive and/or transmit encoded frames.

It is expressly disclosed that the various methods disclosed herein may be performed by a portable communications device such as a handset, headset, or portable digital assistant (PDA), and that the various apparatus described herein may be included within such a device. A typical real-time (e.g., online) application is a telephone conversation conducted using such a mobile device.

In one or more exemplary embodiments, the operations described herein may be implemented in hardware, software, firmware, or any combination thereof. If implemented in software, such operations may be stored on or transmitted over a computer-readable medium as one or more instructions or code. The term “computer-readable media” includes both computer-readable storage media and communication (e.g., transmission) media. By way of example, and not limitation, computer-readable storage media can comprise an array of storage elements, such as semiconductor memory (which may include without limitation dynamic or static RAM, ROM, EEPROM, and/or flash RAM), or ferroelectric, magnetoresistive, ovonic, polymeric, or phase-change memory; CD-ROM or other optical disk storage; and/or magnetic disk storage or other magnetic storage devices. Such storage media may store information in the form of instructions or data structures that can be accessed by a computer. Communication media can comprise any medium that can be used to carry desired program code in the form of instructions or data structures and that can be accessed by a computer, including any medium that facilitates transfer of a computer program from one place to another. Also, any connection is properly termed a computer-readable medium. For example, if the software is transmitted from a website, server, or other remote source using a coaxial cable, fiber optic cable, twisted pair, digital subscriber line (DSL), or wireless technology such as infrared, radio, and/or microwave, then the coaxial cable, fiber optic cable, twisted pair, DSL, or wireless technology such as infrared, radio, and/or microwave are included in the definition of medium. Disk and disc, as used herein, includes compact disc (CD), laser disc, optical disc, digital versatile disc (DVD), floppy disk and Blu-ray Disc™ (Blu-Ray Disc Association, Universal City, Calif.), where disks usually reproduce data magnetically, while discs reproduce data optically with lasers. Combinations of the above should also be included within the scope of computer-readable media.

An acoustic signal processing apparatus as described herein (e.g., apparatus A100 or MF100) may be incorporated into an electronic device that accepts speech input in order to control certain operations, or may otherwise benefit from separation of desired noises from background noises, such as communications devices. Many applications may benefit from enhancing or separating clear desired sound from background sounds originating from multiple directions. Such applications may include human-machine interfaces in electronic or computing devices which incorporate capabilities such as voice recognition and detection, speech enhancement and separation, voice-activated control, and the like. It may be desirable to implement such an acoustic signal processing apparatus to be suitable in devices that only provide limited processing capabilities.

The elements of the various implementations of the modules, elements, and devices described herein may be fabricated as electronic and/or optical devices residing, for example, on the same chip or among two or more chips in a chipset. One example of such a device is a fixed or programmable array of logic elements, such as transistors or gates. One or more elements of the various implementations of the apparatus described herein may also be implemented in whole or in part as one or more sets of instructions arranged to execute on one or more fixed or programmable arrays of logic elements such as microprocessors, embedded processors, IP cores, digital signal processors, FPGAs, ASSPs, and ASICs.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

What is claimed is:

1. An apparatus comprising:
a unified encoder configured to produce a unified encoded signal; and
a memory configured to store the unified encoded signal.

2. The apparatus of claim 1, wherein the unified encoder comprises:
a spherical harmonic analysis module configured to transform an audio coded signal into a first spherical harmonic (SH) based coded signal;
a combiner configured to combine the first SH based coded signal with a second SH based coded signal to obtain a combined SH based coded signal; and
a unified coefficient set encoder configured to produce the unified encoded signal based on the combined SH based coded signal.

3. The apparatus of claim 2, wherein the unified encoder further comprises:
a format detector configured to determine a format of the audio coded signal and producing a corresponding format indicator.

4. The apparatus of claim 2, wherein the audio coded signal is a channel-based audio coded signal.

5. The apparatus of claim 2, wherein the audio coded signal is an object-based audio coded signal.

6. The apparatus of claim 2, wherein the unified encoder further comprises a second spherical harmonic analysis module configured to transform a second audio coded signal into the second spherical harmonic (SH) based coded signal.

7. A method comprising:
producing, with a unified encoder, a unified encoded signal; and
storing, with a memory, the unified encoded signal.

8. The method of claim 7, wherein producing the unified encoded signal comprises:
transforming an audio coded signal into a first spherical harmonic (SH) based coded signal;
combining the first SH based coded signal with a second SH based coded signal to generate a combined SH based coded signal; and
producing the unified encoded signal based on the combined SH based coded signal.

9. A method of audio signal processing, said method comprising:
receiving a plurality of bandwidth compressed spherical harmonic coefficients, having a mode and order, over a transmission channel; and
decoding the received bandwidth compressed spherical harmonic coefficient to produce a plurality of synthetic spherical harmonic coefficients.

10. The method of claim 9, further comprising rendering the plurality of synthetic spherical harmonic coefficients with a spherical wave renderer to produce a sound field.

11. The method of claim 9, further comprising multiplying each synthetic spherical harmonic coefficient in the plurality of coefficients by a phase-shift constant to produce a plurality of phase-shifted synthetic spherical harmonic coefficients.

12. The method of claim 11, further comprising rendering the plurality of phase shifted synthetic spherical harmonic coefficients with a spherical wave renderer to produce a sound field.

13. The method of claim 11, wherein the phase-shift constant used in the multiplication is based on the order of the bandwidth compressed spherical harmonic coefficients.

14. The method of claim 11, further comprising retrieving the phase-shift constant from a lookup-table.

15. The method of claim 11, wherein the phase-shift constant is calculated based on the order of the bandwidth compressed spherical harmonic coefficients.

16. The method of claim 9, further comprising dividing each synthetic spherical harmonic coefficient in the plurality of coefficients by a phase-shift constant to produce a plurality of phase-shifted synthetic spherical harmonic coefficients.

17. The method of claim 16, wherein the plurality of phase shifted synthetic spherical harmonic coefficients are rendered with a plane wave renderer to produce a sound field.

18. A device comprising:
a decoder configured to decode a plurality of bandwidth compressed spherical harmonic coefficients, having a mode and order, configured to produce a plurality of synthetic spherical harmonic coefficients.

19. The device of claim 18, further comprising a spherical wave renderer, coupled to the decoder, configured to produce a sound field based on the plurality of synthetic spherical harmonic coefficients.

20. The device of claim 18, further comprising a plane wave renderer, coupled to the decoder, configured to produce a sound field based on the plurality of synthetic spherical harmonic coefficients.

21. The device of claim 18, further comprising a divider, coupled to the decoder, configured to divide the output of the decoder by a phase-shift constant term.

22. The device of claim 21, further comprising a plane wave renderer configured to produce a sound field from the resulting output of the divider.

23. The device of claim 21, wherein the phase-shift constant term is based on the order of the plurality of the synthetic spherical harmonic coefficients.

24. The device of claim 21, wherein the phase-shift constant term is retrieved from a lookup-table.

25. The device of claim 21, wherein the phase-shift constant term is calculated based on the order of the plurality of the synthetic spherical harmonic coefficients.

26. The device of claim 21, further comprising a plane wave renderer configured to produce a sound field from the resulting output of the divider.

27. The device of claim 18, further comprising a multiplier, coupled to the decoder, configured to multiply the output of the decoder by a phase-shift constant term.

28. The device of claim 27, wherein the phase-shift constant term is based on the order of the plurality of the synthetic spherical harmonic coefficients.

29. The device of claim 27, wherein the phase-shift constant term is retrieved from a lookup-table.

30. The device of claim 27, wherein the phase-shift constant term is calculated based on the order of the plurality of the synthetic spherical harmonic coefficients.
